(19) United States
(12) Patent Application Publication
(10) Pub. No.: US 2026/0115889 A1
(43) Pub. Date: Apr. 30, 2026

(54) MODULAR TOOL TRAY ORGANIZER

(71) Applicant: Jonathan Hurley, Columbia Falls, MT (US)

(72) Inventor: Jonathan Hurley, Columbia Falls, MT (US)

(21) Appl. No.: 19/264,438

(22) Filed: Jul. 9, 2025

Related U.S. Application Data
(63) Continuation-in-part of application No. 18/770,501, filed on Jul. 11, 2024.

(51) Int. Cl. B25H 3/06; B65D 25/10; B65D 25/28

(52) U.S. Cl. CPC B25H 3/06; B65D 25/108; B65D 25/282

(57) ABSTRACT

A modular tool tray organizer is composed of a plurality of rectilinear shaped base panels, each having side edges and a bottom surface. A first series of tubes projecting from a first side edge of a panel and a first series of sockets are formed in a second side edge of the panel. The panels of the tray are interconnected by engaging the first series of tubes projecting from a first panel into a series of sockets of an adjacent panel.

### CROSS-REFERENCE TO RELATED APPLICATION

This application is a continuation-in-part of U.S. patent application Ser. No. 18/770501, filed Jul. 11, 2024, the entire contents of which are incorporated herein by reference.

### BACKGROUND

For efficiency, workmen and mechanics assemble together in advance the tools needed to carry out a specific task. To this end, fixed-sized carrying trays are available. Such trays may have compartments for placing tools or other items, such as fasteners or hardware members. However, it would be desirable to be able to configure a tool organizing and carrying tray to hold specific tools and also optionally at specific locations on the tray to help keep track of the tools and not leave a tool at the work site. Also, it would be desirable to configure a tool organizing and carrying tray to a desired size and/or shape to accommodate all of the tools and hardware or other items needed for a task. These needs are sought to be addressed by the modular tool tray organizer of the present disclosure.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In accordance with one embodiment of the present disclosure, a modular tool tray organizer is provided. The modular tool tray organizer includes a plurality of rectilinear-shaped base panels comprising side edges, a top surface, at least one first connection projection projecting from at least a first side edge, at least one first socket formed in at least a second side edge for receiving the at least one first connection projection of an adjacent base panel, and two adjacent base panels interconnected by pressing the adjacent side edges of the adjacent base panels towards each other in a direction parallel to the top surfaces of the adjacent base panels to engage the at least one first connection projection into a first socket.

In any of the embodiments described herein, wherein the at least one first connection projection is disposed below the top surface of the base panel.

In any of the embodiments described herein, wherein the at least one first socket is sized and shaped to snuggly receive the at least one first connection projection.

In any of the embodiments described herein, wherein the at least one first connection projection is rectilinear in shape.

In any of the embodiments described herein, wherein the at least one first connection projection comprises a body portion and a tongue connected to and spaced from the body portion.

In any of the embodiments described herein, wherein the at least one first socket defining a hollow for receiving the tongue therein.

In any of the embodiments described herein, wherein the tongue is connected to the body portion at a flexible juncture with the body portion, the tongue flexing at the flexible juncture to engage the hollow, thereby to place the at least one first projection into locking relationship with the at least one first socket.

In any of the embodiments described herein, further comprising a sill extending along the margins of the hollow for support of the first projection.

In any of the embodiments described herein, wherein at least one second socket extending downwardly from the top surface of the base panel.

In any of the embodiments described herein, further comprising a tool holder configured to receive a mechanics tool, the tool holder comprising a downwardly extending second connection projection receivable into the least one second socket.

In any of the embodiments described herein, wherein the tool holder comprising spaced-apart upright sidewalls for receiving a mechanics tool between the side walls, and the downwardly extending second connection projection extending downwardly from the upright sidewalls.

In any of the embodiments described herein, wherein the tool holder comprising an upwardly projecting column, and wherein the downwardly extending second connection projection extending downwardly from the upwardly projecting column.

In any of the embodiments described herein, wherein the upwardly projecting column is configured to receive a mechanics tool socket.

In any of the embodiments described herein, further comprising a wall structure comprising a wall section and a second connection projection extending downwardly from the wall section to be receivable within a second socket of a base panel, with the wall section extending along the top surface of the base panel.

In any of the embodiments described herein, wherein the wall section is selected from the group including a straight wall section and a curved wall section.

In any of the embodiments described herein, further comprising a handle engageable with at least one base panel, the handle comprising a manually graspable section and at least one third connection projection extending from the manually graspable section to be receivable within a first socket.

In accordance with another embodiment of the present disclosure, a base panel is provided for forming a modular tool tray organizer. The base panel includes a rectilinear body portion having side edges and a top surface, at least one first connection projection projecting from at least a first side edge, and at least one first socket formed in at least a second side edge for receiving the at least one first connection projection of an adjacent body portion, wherein two adjacent base panels are interconnected by pressing the adjacent side edges of the adjacent base panels towards each other in a direction parallel to the top surfaces of the adjacent base panels to engage the at least one first connection projection into a first socket.

In any of the embodiments described herein, wherein the at least one first connection projection is disposed below the top surface of the body portion.

In any of the embodiments described herein, wherein the at least one first socket is sized and shaped to snuggly receive the at least one first connection projection.

In any of the embodiments described herein, wherein the at least one first connection projection is rectilinear in shape.

In any of the embodiments described herein, wherein the at least one first connection projection comprises a body portion and a tongue connected to and spaced from the body portion, the tongue configured to engage into locking relationship with the at least one first socket of an adjacent body portion.

In accordance with another embodiment of the present disclosure, a modular tool tray organizer is provided. The modular tool tray organizer includes a plurality of rectilinear-shaped panels interlockable together to form in a desired configuration base of the tool tray organizer, the panels comprising side edges, a bottom portion, a first blade connector projecting from a first side edge of a panel, a first slot formed in a second side edge of the panel for receiving a blade connector, and the panel and a first adjacent panel interconnected by engaging the first blade connector projecting from the panel into a slot of the first adjacent panel.

In any of the embodiments described herein, wherein the first blade connector of the panel comprising a first blade spaced from the first side edge of the panel.

In any of the embodiments described herein, wherein the first blade connector of the panel comprising a first web extending between the first blade and the first side edge of the panel.

In any of the embodiments described herein, wherein the web extending between the bottom portion of the panel and a lower edge portion of the first blade, wherein the first blade projecting upwardly from the first web to define an upper edge portion.

In any of the embodiments described herein, comprising a first lip projecting from the upper edge portion of the first blade to overlie the first web.

In any of the embodiments described herein, comprising a second lip extending along the first slot, wherein a lip of a blade connector of a second adjacent panel sliding over the second lip of the first slot of the panel to lock together the second lip of the first slot of the panel with the lip of the blade connector of the second adjacent panel.

In any of the embodiments described herein, comprising a second blade connector projecting from a third side edge of the panel adjacent the first side edge of the panel and a second slot formed in a fourth side edge of the panel adjacent the second side edge of the panel.

In any of the embodiments described herein, wherein the second blade connector comprising a second blade spaced from the third side edge of the panel.

In any of the embodiments described herein, wherein the second blade connector comprising a second web extending between the second blade and the third side edge of the panel.

In any of the embodiments described herein, wherein the second web extending between the bottom portion of the panel and a lower edge portion of the second blade, wherein the second blade projecting upwardly from the second web to define an upper edge portion.

In any of the embodiments described herein, comprising a third lip projecting from the upper edge portion of the second blade to overlie the second web.

In any of the embodiments described herein, comprising a fourth lip extending along the second slot, wherein a lip of a blade connector of a third adjacent panel sliding over the fourth lip of the second slot of the panel to lock together the fourth lip of the panel with the lip of the blade connector of the third adjacent panel.

In any of the embodiments described herein, wherein the panel is configured to define a top portion and plurality of sockets extending downwardly from the top portion.

In any of the embodiments described herein, wherein the sockets occupy substantially the entire area of the panel.

In any of the embodiments described herein, further comprising at least one tool holder configured to receive a mechanics tool, the tool holder comprising a downwardly extending projection receivable into least one socket of a panel.

In any of the embodiments described herein, further comprising a wall structure comprising a plurality of wall sections, at least one downwardly extending projection extending downwardly from the wall sections to be receivable within at least one socket of a panel, with the wall section extending along the top portion of the panel.

In any of the embodiments described herein, further comprising a handle engageable with at least one panel, the handle comprising a manually graspable section and a base section, and either a handle blade connector projecting from the base section of the handle to be receivable within a second slot of the panel or a handle slot disposed in the base section of the handle to receive a blade connector of the panel.

In accordance with another embodiment of the present disclosure, a modular tool tray organizer is provided. The modular tool tray organizer includes a plurality of rectilinear-shaped panels interlockable together to form the tool carrying portion of the tool tray organizer of a desire configuration, each of the panels comprising four side edges, a bottom portion, a first blade connector projecting from a first side edge of the panel, a first slot formed in a second side edge of the panel, a second blade connector projecting from a third side edge of the panel, a second slot formed in a fourth side edge of the panel, wherein two panels are interconnected by engaging the first or second blade connector of a first panel into a first or second slot of an adjacent second panel.

In any of the embodiments described herein, wherein the first and second blade connectors further comprising a blade locking lip extending along the first and second blade connectors, wherein the first and second slots comprising a slot locking lip extending along the first and second slots, wherein a blade locking lip is lockingly engageable with a slot locking lip of a first adjacent panel, and wherein a slot locking lip is lockingly engageable with a blade locking lip of a second adjacent panel.

In any of the embodiments described herein, wherein each of the base panels is configured to define a top portion and a plurality of sockets extending downwardly from the top portion, wherein the sockets are configured to receive a plug extending downwardly from a structure selected from the group consisting of a tool holder configured to receive a mechanics tool and a wall structure section, the wall structure section configurable to form part of a perimeter wall or a dividing wall of the tool tray organizer.

In accordance with another embodiment of the present disclosure, a modular tool tray organizer is provided. The modular tool tray organizer includes a plurality of rectilinear-shaped panels interlockable together to form in a desired configuration of the base of the tool tray organizer, the panels comprising side edges, a bottom portion, a male connector structure projecting from a first side edge of a panel, a female connector structure formed along a second side edge of the panel; and the panel and a first adjacent panel interconnected by engaging the male connector structure of the panel with a female connector structure of the first adjacent panel.

In any of the embodiments described herein, wherein the male connector structure comprising at least one male projection member projecting from the first side edge of the panel, and the female connector structure is configured to receive the at least one male projection member.

In any of the embodiments described herein, wherein the at least one male projection member is selected from the group including a plug, a detent, a blade, a tube, a post; and wherein the female connector structure is configured to receive the plug, detent, blade, tube, and post, respectively.

In accordance with another embodiment of the present disclosure, a modular tool tray organizer is provided that includes a plurality of rectilinear-shaped panels interlockable together to form in a desired configuration base of the tool tray organizer. The panels include side edges, a bottom portion, a first series of tubes projecting from a first side edge of a panel, a first series of sockets formed in a second side edge of the panel, and the panel and a first adjacent panel interconnected by engaging the first series of tubes projecting from the panel into a series of sockets of the first adjacent panel.

In any of the embodiments described herein, wherein the first series of tubes extend along and are spaced from the first side edge of the panel.

In any of the embodiments described herein, wherein the first series of tubes extending upwardly from a first ledge extending along the first side edge of the panel.

In any of the embodiments described herein, wherein the first series of sockets extend along a second ledge extending along the second side edge of the panel.

In any of the embodiments described herein, comprising a second series of tubes projecting from a third side edge of the panel adjacent the first side edge of the panel and a second series of sockets formed in a fourth side edge of the panel adjacent the second side edge of the panel.

In any of the embodiments described herein, wherein the second series of tubes extend along and are spaced from the third side edge of the panel.

In any of the embodiments described herein, wherein the second series of tubes extend upwardly from a third ledge extending along the third side edge of the panel.

In any of the embodiments described herein, wherein the second series of sockets extend along a fourth ledge extending along a fourth side edge of the panel.

In any of the embodiments described herein, wherein the tubes have at least one slot formed in the tube and extending along the length of the tube.

In any of the embodiments described herein, wherein the tubes have a distal end and the slot extends to the distal end of the tube.

In any of the embodiments described herein, wherein the tubes define a rim portion extending outwardly from the distal ends of the tubes.

In any of the embodiments described herein, wherein the tubes have at least two slots formed in the tube and extending along the length of the tube.

In any of the embodiments described herein, wherein the tubes have a distal end and the at least two slots extend to the distal end of the tubes.

In any of the embodiments described herein, wherein the tubes define rim portions extending outwardly from the distal ends of the tubes.

In any of the embodiments described herein, wherein the panel is configured to define a top portion and a plurality of apertures extending downwardly from the top portion.

In any of the embodiments described herein, wherein the apertures occupy substantially the entire area of the panel.

In any of the embodiments described herein, further comprising at least one tool holder configured to receive a mechanics tool, the tool holder comprising a downwardly extending projection receivable into at least one aperture of a panel.

In any of the embodiments described herein, further comprising a wall structure comprising a plurality of wall sections, at least one downwardly extending projection extending downwardly from the wall sections to be receivable within at least one aperture of a panel, with the wall section extending along the top portion of the panel.

In any of the embodiments described herein, further comprising a handle engageable with at least one panel, the handle comprising a manually graspable section and a base section, and either a series of tubes projecting from the base section of the handle to be receivable within the series of slots of the panel or a series of slots formed in the base section of the handle to engage with a series of tubes of the panel.

In accordance with another embodiment of the present disclosure, a modular tool tray organizer that includes a plurality of rectilinear-shaped panels interlockable together to form the tool carrying portion of the tool tray organizer of a desired configuration is provided. Each of the panels includes four side edges, a bottom portion, a first series of tubular connectors extending along and projecting from a first side edge of the panel, a first series of slots extending along a second side edge of the panel, a second series of tube connectors extending along and projecting from a third side edge of the panel, a second series of slots extending along a fourth side edge of the panel, wherein two panels are interconnected by engaging the first or second series of blade connectors of a first panel into a first or second series of slots of an adjacent second panel.

In any of the embodiments described herein, wherein each of the base panels is configured to define a top portion and a plurality of apertures extending downwardly from the top portion, wherein the apertures are configured to receive a plug extending downwardly from a structure selected from the group consisting of a tool holder configured to receive a mechanics tool and a wall structure section, the wall structure section configurable to form part of a perimeter wall or a dividing wall of the tool tray organizer.

In accordance with another embodiment of the present disclosure, a modular tool tray organizer that includes a plurality of rectilinear-shaped panels interlockable together to form in a desired configuration of the base of the tool tray organizer is provided. The panels include side edges, a bottom portion, a male connector structure projecting from a first side edge of a panel, a female connector structure formed along a second side edge of the panel, and the panel and a first adjacent panel interconnected by engaging the male connector structure of the panel with a female connector structure of the first adjacent panel.

In any of the embodiments described herein, wherein the male connector structure comprising at least one male projection member projecting from the first side edge of the panel, and the female connector structure is configured to receive the at least one male projection member.

In any of the embodiments described herein, wherein the at least one male projection member is selected from the group including a plug, a detent, a blade, a tube, a post; and wherein the female connector structure is configured to receive the plug, detent, blade, tube, and post, respectively.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a pictorial view of an assembled modular tool organizer tray 100 configured to hold various types of mechanics tools;

FIG. 2 shows a portion of the tray base formed by assembled base panels;

FIG. 3 is a cross-sectional view of FIG. 1, taken along lines 3-3 of FIG. 1;

FIG. 4A is an enlarged, exploded cross-sectional view of several base panels and mechanics tool holders;

FIG. 4B is a view of the components of FIG. 4A, showing the components assembled together;

FIG. 5A is a pictorial view of a base panel taken from above;

FIG. 5B is a pictorial view of the base panel of FIG. 5A taken from below;

FIG. 5C is a plan view of the base panel of FIG. 5A;

FIG. 5D is a side elevational view of the base panel of FIG. 5A;

FIG. 5E is a bottom view of the base panel of FIG. 5A;

FIG. 6A is a pictorial view taken from above of another embodiment of a tray base panel;

FIG. 6B is a pictorial view taken from of the tray panel of FIG. 6A, taken from below the panel;

FIG. 7A is a plan view of the tray panel of FIG. 6A;

FIG. 7B is a cross-sectional view of FIG. 7A, taken along lines 7B-7B thereof;

FIG. 8A is a pictorial view of a modular tool organizer tray 200 assembled from four panels shown in FIGS. 6A-7B;

FIG. 8B is a bottom view of the FIG. 8A;

FIG. 9A is a plan view of FIG. 8A;

FIG. 9B is a cross-sectional view of FIG. 9A taken along Section 9B-9B thereof;

FIG. 10 is an enlarged partial cross-sectional view of FIG. 9B within the circle identified as 10;

FIG. 11 is an enlarged partial cross-sectional view of FIG. 9B within the circle identified as 11.

FIG. 12 is a pictorial view taken from above of another embodiment of a tray base panel;

FIG. 13 is a pictorial view of the tray panel of FIG. 12, taken from below the panel;

FIG. 14 is a pictorial view taken from above of four base trays prior to being assembled to form a unitary base tray;

FIG. 15 is a plan view of FIG. 12;

FIG. 16 is a cross-sectional view of FIG. 15 taken along section 16-16 thereof;

FIG. 17 is a pictorial view of a modular tool organizer tray 300 assembled from the four panels shown in FIG. 14;

FIG. 18 is a bottom view of the FIG. 17;

FIG. 19 is a plan view of FIG. 17;

FIG. 20 is a cross-sectional view of FIG. 19 taken along section 20-20 thereof;

FIG. 21 is an enlarged partial cross-sectional view of FIG. 20 within the circle identified as 21;

FIG. 22 is a partial pictorial view of 17, showing the handle 320 detached from the tray panel 304.

### DETAILED DESCRIPTION

Various example embodiments of the present disclosure are described below with reference to the accompanying drawings in which some example embodiments are illustrated. In the figures, the thicknesses of lines, layers and/or regions may be exaggerated for clarity.

While example embodiments are capable of various modifications and alternative forms, embodiments thereof are shown by way of example in the figures and are described in detail below. It should be understood, however, that there is no intent to limit example embodiments to the particular forms disclosed, but on the contrary, example embodiments are to cover all modifications, equivalents, and alternatives falling within the scope of the disclosure.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be considered in the specific context this definition is given herein.

In the following description, numerous specific details are set forth in order to provide a thorough understanding of exemplary embodiments of the present disclosure. It will be apparent to one skilled in the art, however, that many embodiments of the present disclosure may be practiced without some or all of the specific details. Further, it will be appreciated that embodiments of the present disclosure may employ any combination of features described herein.

The present application may include references to directions, such as “forward,” “rearward,” “front,” “back,” “ahead,” “behind,” “upward,” “downward,” “above,” “below,” “top,” “bottom,” “right hand,” left hand,” “in,” “out,” “extended,” “advanced,” “retracted,” “proximal,” “distal,” “central,” “vertical,” etc. These references and other similar references in the present application are only to assist in helping describe and understand the present invention and are not intended to limit the present invention to these directions or locations.

The present application may also reference quantities and numbers. Unless specifically stated, such quantities and numbers are not to be considered restrictive, but exemplary of the possible quantities or numbers associated with the present application. Also, in this regard, the present application may use the term “plurality” to reference a quantity or number. In this regard, the term “plurality” is meant to be any number that is more than one, for example, two, three, four, five, etc.

The present application may include modifiers such as the words “generally,” “approximately,” “about”, or “substantially.” These terms are meant to serve as modifiers to indicate that the “dimension,” “shape,” “temperature,” “time,” or other physical parameter in question need not be exact, but may vary as long as the function that is required to be performed can be carried out. For example, in the phrase “generally circular in shape,” the shape need not be exactly circular as long as the required function of the structure in question can be carried out. If a quantitative value is needed to render the applicable parameter sufficiently definite, the applicable parameter is within five percent (5%) of the designated parameter value.

In the present application, the term “rectilinear” is used to designate a shape defined by straight lines that meet at right angles. Non-limiting examples of rectilinear shapes include squares, rectangles, crosses, u-shapes, angle shapes, etc.

Further, the term “mechanic's tools” may include all manner of tools used by mechanics, including, but not limited to, wrenches, pliers, screw drivers, sockets, socket wrenches, rachet wrenches, hex wrenches, etc.

In the following description, various embodiments of the present disclosure are described. In the following description and in the accompanying drawings, the corresponding systems assemblies, apparatus, and units may be identified by the same part number, but with an alpha suffix or by a prime (“′”) or double prime (“″”) or even a triple prime (“′″”) designation. The descriptions of the parts/components of such systems assemblies, apparatus, and units that are the same or similar are not repeated so as to avoid redundancy in the present application.

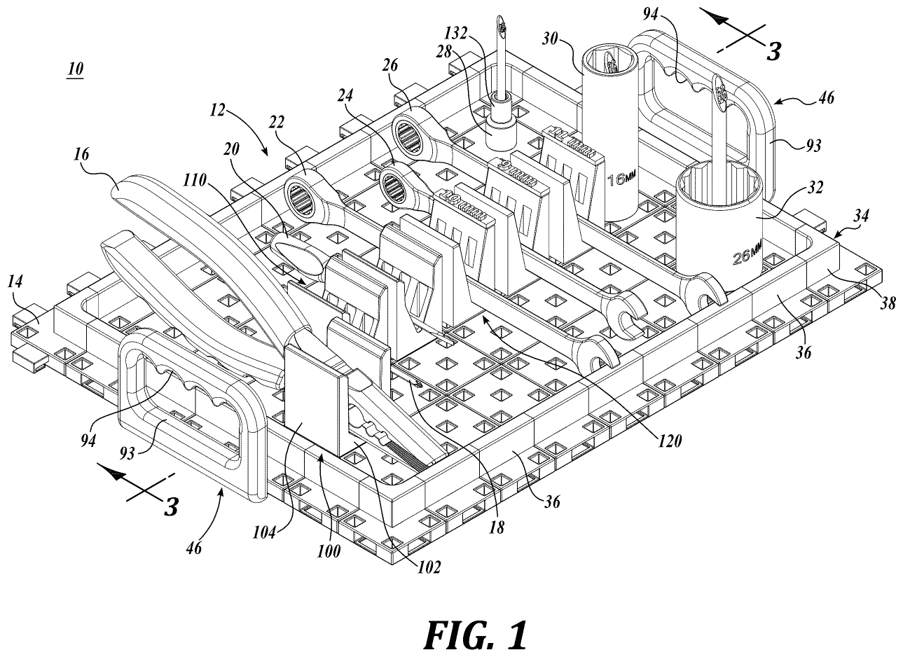

Referring initially to FIGS. 1-3, in one embodiment of the present disclosure, a tray assembly 10 includes in basic form a tray base 12 composed of individual base panels 14 that are “snap fit” or otherwise locked together to form the base 12 with sufficient strength and durability to hold and support a number of tools, such as mechanics tools, in an organized matter. Such mechanics tools can include, for example, pliers 16, screwdrivers 18 and 20, wrenches 22, 24, and 26, and sockets 28, 20, and 32. Each of these tools can be held in place on the tray base 12 by tool holders secured to the tray base as discussed more fully below.

A wall 34 is shown as extending around the perimeter of the tray base 12. The perimeter wall 34 can be composed of longitudinal sections 36 and corner sections 38 that snuggly engage downwardly into openings or cavities or sockets 40 extending downward from the top surface 42 of the base panel 14. The perimeter wall 34 helps to retain smaller items as well as nuts, bolts, and other hardware or fasteners on the tray assembly 10.

Handles 46 are provided so that the tray assembly 10 can be conveniently carried about. The handles 46 also “snap fit” or otherwise lock with side openings, cavities, or sockets 48 formed in the sides of the base panels 14.

Although the forging briefly describes the basic construction of the tray assembly 10, it is to be understood that the tray assembly 10 need not include all of the above described elements. Rather, the tray assembly is defined by the claims of the present application. Further, it is to be understood that the configuration and construction of the base panel 14 constitutes a separate aspect of the present disclosure.

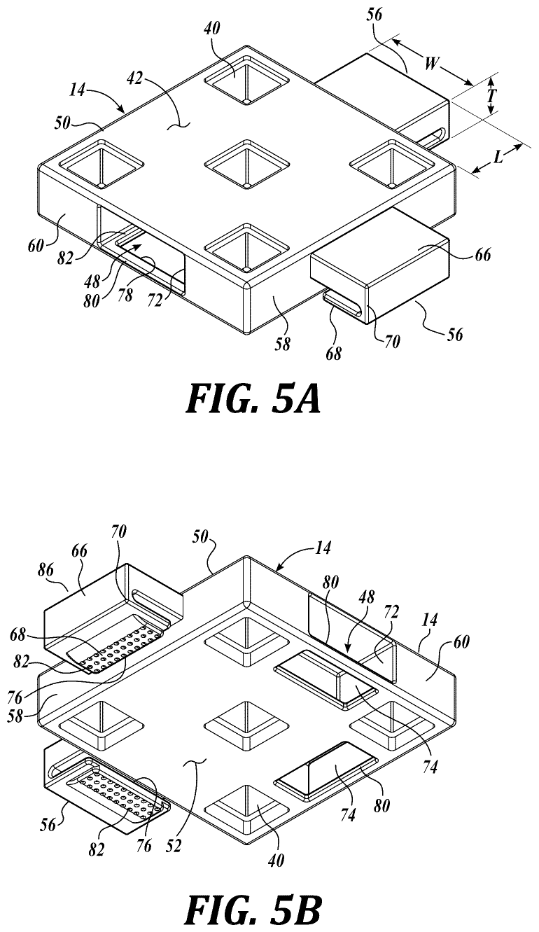

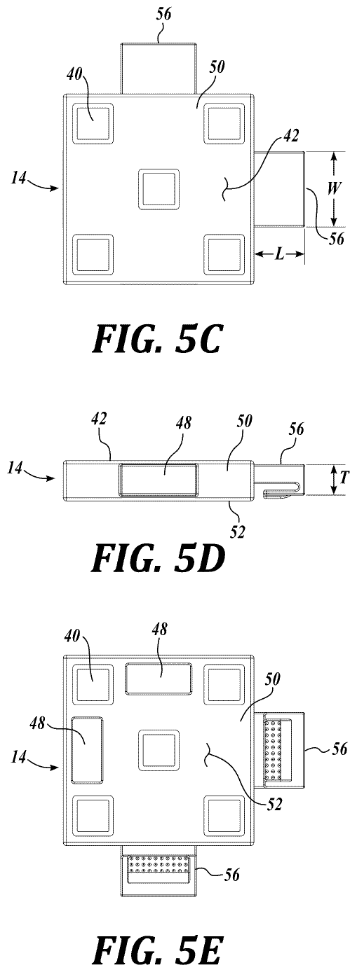

Discussing the construction of the tray assembly 10, in greater detail, as noted above, the tray base 12 of the tray assembly is constructed from individual base panels 14, see FIGS. 5A-5E. The base panel 14 is shown as being square in shape. However, the base panel can be of other shapes, including of other rectilinear shapes, such as rectangular, cross-shaped, U-shaped, and angle-shaped.

The tray base panel 14 includes a square-shaped body portion 50 with top openings or cavities or sockets 40 extending downwardly from the top surface 42 of the body portion. Although not essential, the sockets 40 extend all the way through the body portion so as to be open at the bottom surface 52 of the body portion.

The top sockets 40 are shown as being of square cross-sectional shape; however, the sockets 40 can be of other shapes, for example hexagonal or octagonal. Moreover, five sockets 40 are shown as formed in the tray base panel 14, one socket in the middle of the body portion 50, and a socket adjacent each corner of the body portion 50. However, it is to be understood that a greater number or a fewer number of sockets can be utilized. Further, the sockets can be in other locations than shown in FIGS. 5A-5E.

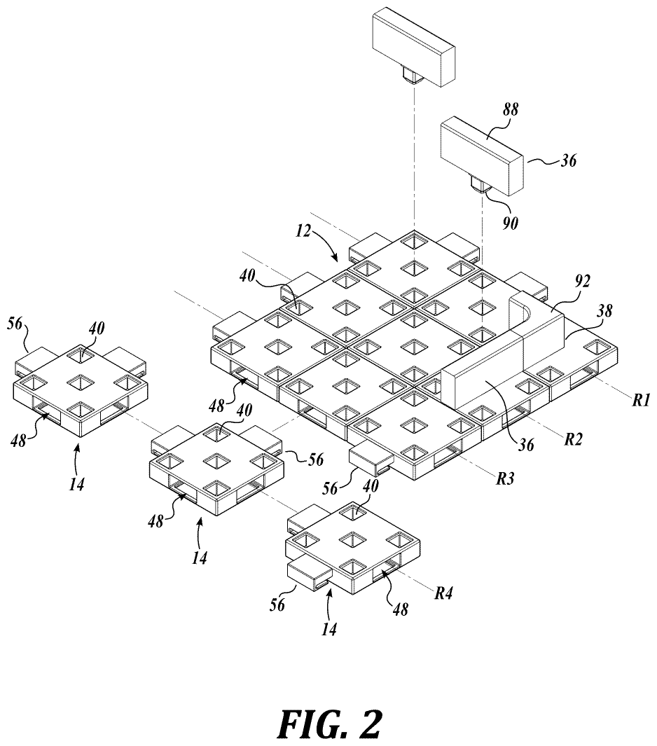

The tray base panels 14 are assembled and locked together to form a continuous tray base 12 of a desired shape and size. In this regard, connection projections 56 project from two adjacent side edges 58 of the body portion 50 to snuggly “snap fit” or otherwise lock into close fitting, correspondingly shaped side sockets 48 formed in the side edges 60 of adjacent base panels 14, see also FIG. 2. The connection projections 56 may be generally rectangular in shape, having a width W and a length L as well as a thickness T. Further, the connection projections 56 are constructed with an upper body portion 66 and the lower tongue portion 68 connected to the upper body portion 66 by a joint 70 that allows the tongue portion to flex relative the upper body portion 66.

The connection projections 56 are sized and shaped to be snuggly engageable into a close-fitting side socket 48 of an adjacent base panel 14, see FIG. 2. The side socket 48 has an opening 72 at the side edge 60 of the base panel and extends into the interior of the body portion 50. The side socket 48 also includes an opening or hollow 74 in the bottom surface 52 of the body portion 50 to receive the tongue portion in locking relationship. In this regard, the trailing edge 76 of the tongue portion 68 bears against edge 78 of the bottom opening or hollow 74 of the side socket 48 to lock the connection projection 56 into a side socket 48.

It will be appreciated that during the insertion of a connection projection 56 into a side socket 48, the tongue portion 68 flexes upwardly towards the underside of the body portion 66 due to the presence of the entry sill portion 80 extending across the side socket opening 72. Once the trailing edge 76 of the tongue portion 68 has slid past the entry sill 80, the tongue portion 48 can resume its nominal configuration, which places the trailing edge 76 of the tongue portion at the same elevation as the sill 80 and thus prevents the removal of the connection projection 56 from the side socket 48 due to the trailing edge 76 abutting the sill 80.

Bumps 82 or other forms of projections can extend downwardly from the bottom surface of the tongue portion 68 to facilitate the sliding of the tongue portion over the sill 80 with reduced friction relative to if the bottom surface of the tongue portion were smooth. Rather than utilizing bumps 82, ridges can extend along the bottom surface of the tongue portion 68 in the direction parallel to the direction of sliding movement of the tongue portion 68 into the side socket opening 72. Such ridges can also function to reduce the friction between the bottom surface of the tongue portion 68 and the sill 80.

The tray assembly can be disassembled or reconfigured by pressing upward on the underside of a tongue portion so that the tongue trailing edge is positioned above the corresponding sill 80, thereby unlocking the connection projection 56 from a corresponding side socket 48. This allows the connection projection 56 to be slidably disengaged from the corresponding side socket 48.

The upper surface of the body portion 66 of the connection projection 56 is spaced directly beneath the top surface 42 of the base panel. Likewise, the top of the side sockets 48 are correspondingly spaced below the top surface of the base panel. In this manner, the connection projection 56 is protected from the tools or other items being carried on the tray 10. This reduces the likelihood of damage caused to the connection projections. Also, the connection projections 56 are less likely to be subjected to dirt, grit, or other foreign substances that make it difficult to disengage a connection projection from a side socket when disassembling the tray assembly 10 or reconfiguring the tray assembly.

It will be appreciated that in the foregoing construction the base panels 14 are not only securely locked together, but also are maintained in coplanar relationship to each other so as to present a flat or planar top surface for the tray base 12. In this regard, the top surface of the body portion 66 of the connection projection 56 bears against the bottom surface of the top of the adjacent base panel 14 to which the base panel in question is connected. The top surface of the body portion 66 presents a large bearing surface for the top surface 42 of the adjacent base panel.

In addition, the sill 80 provides support for the underside of the body portion 66 of the connection projections. Further, side ledges 82 extend inwardly into the side socket from each end of the sill 80 to also provide support for the underside of the tongue portion 68, adding to the structural integrity of the interconnection between adjacent base panels 14.

Also, the rectilinear configuration of the connection projections 56 and the corresponding shape of the side sockets 48 prevent adjacent base panels from tilting or twisting relative to each other about an axis parallel to the direction that the connection projection 56 extends from its tray base 42.

Referring to FIG. 2, it will be appreciated that by constructing the base panels 14 with two connection projections 56 at adjacent side edges 58 of the body portion 50 and with two side sockets 48 at adjacent side edges 60, the base panels 14 can be conveniently assembled into desired configurations, sizes, and shapes. For example, the base panels 14 can be assembled into rows, such as rows R1, R2, R3, and R4 and then the rows assembled as a unit with adjacent rows.

FIGS. 2 and 5A-5E illustrate one form of a connecting tray base panels according to the present disclosure. However, the present disclosure is not limited to that illustrated in FIGS. 2 and 5A-5E. The connection projections 56 could be replaced with other structures. For example, the connection projections could be replaced with two or more rods or similar members that project from spaced apart locations of a side edge 58 of a base panel 14 to engage into close filling sockets formed in the adjacent side edge 60 of an adjacent base panel. This construction will also enable the base panels 14 to be not only locked together, but also maintained in coplanar relationship to each other.

Next referring specifically to FIGS. 1, 2, and 3, a perimeter wall 34 is shown as extending along the perimeter of the tray base 12. The perimeter wall 34 may be constructed from longitudinal sections 36 and corner sections 38. The longitudinal sections 36 may be constructed from elongate wall portions 88 and downward extending connection projections 90 that are sized and shaped to be closely and snuggly inserted into the top sockets 40. The intersection of the top sockets 40 and the top surface 42 of the base panel can be radiused or chamfered to guide the connection projection 90 down into the top sockets 40. The connection projections 90 are formed in a cross-sectional shape matching that of the top sockets 40 so that the wall portions 88 maintain a fixed orientation relative to the base panel 14 on which the perimeter wall is located.

The corner sections 38 are constructed similarly to the longitudinal sections 36, but with the exception that the wall portion 92 has two sections at right angles to each other to form a corner. As with the longitudinal sections 36, the corner sections 38 also include a downwardly extending connection projection 90 to be snugly receivable within a top socket 40.

It will be appreciated that the wall portions 88 and 92 are sized so that the longitudinal section 36 and corner sections 38 may form a continuous wall or edge on the tray base 12. Although the wall sections 36 and 38 are shown as sized to match the base panel on which they are mounted, the wall sections can be longer than a base panel. In this regard, the wall sections can be configured to be engageable with two of even a larger number of separate base panels 14.

Although the longitudinal sections 36 and corner sections 38 are shown in FIG. 1 to form a perimeter wall 34, such sections can instead be used to form one or more dividing walls extending across or along the tray base. In this manner, the tray base can be divided into sections or areas in which particular items may be stored, such as, for example, hardware of a certain size and/or type or fasteners of a certain size and/or type.

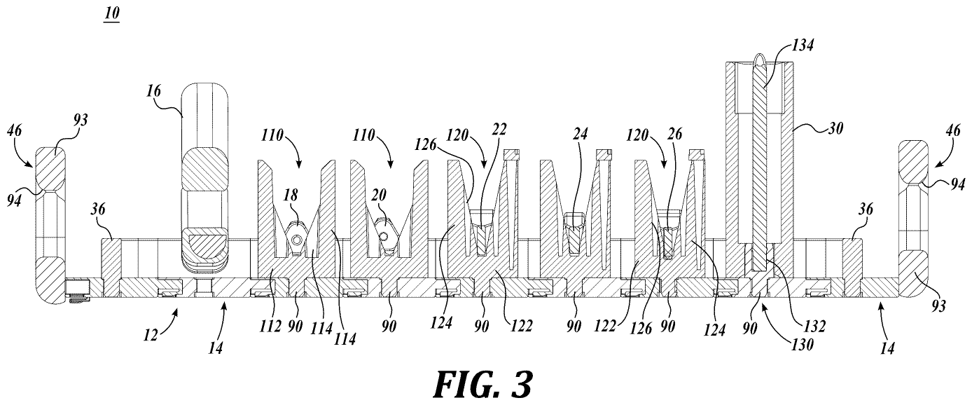

Referring to FIGS. 1 and 3, the tray assembly 10 also includes handles 46 to conveniently and securely hold the tray 10 when, for example, carrying the tray form place to place. The handles 46include a manually graspable frame 93 that extends upwardly from each end of the tray base 12. Finger grooves 94 can be provided under the top section of the frame to assist in securely holding the tray handle.

As shown in FIG. 3, the handles 46 include connection projections 56 for insertion into side sockets 48 of the base panel(s) 14 to which the handle 46 is attached. In this manner, the handles 46can be attached to the base panel(s) 14 in the same manner that base panels 14 are attached together, thereby providing s secure interconnection with adjacent base panels.

It is to be understood that the handles 46 can be of a desired length along the end of the tray assembly 10. The handles 46 are shown as connecting to base panels 14 with one base panel located between the connection base panels. However, the handles 46 can be of other lengths, and can be configured to connect to each base panel 14 located along the length of the handle.

As noted above, various configurations of tool holders can be used with the tray assembly 10 to hold different mechanics tools, for example, pliers, screw drives, wrenches, socket wrenches, sockets for socket wrenches, hammers, etc. As shown in FIGS. 1 and 3, a first holder 100 is configured to hold a pair of pliers 16. The holder 100 includes a base section 102 that rests on the top of the tray base. Spaced apart wall sections 104 extent upwardly from the base section 102 to receive the pliers therebetween.

A connection projection 90 extends downward from the underside of the base section 102 to be snuggly receivable within top socket 40 of a base panel 14. The connection projection 90 can be inserted into a desired top socket 40 so as to position the holder 100 on the tray 10, and thus place the pliers 16 at a desired location on the tray 10. Such location may depend on, for example, the size of the pliers, the size of the tray assembly 10, as well the desired location relative to the other tools being held and organized on the tray assembly.

Holders 100 can be of various sizes for holding different sizes and types of tools in addition to pliers, for example, the handle of a hammer or mallet or a tube of caulk or a caulking gun. In this regard, the distance separating the upright wall sections 104 can be altered, as well as the height and length of the upright wall sections. Further, the base section 102 can be curved to correspond to the curvature of a hammer or mallet handle or the diameter of a tube of caulk.

As shown in FIGS. 1 and 3, holders 110 are shown as holding screwdrivers 18 and 20 on tray 10. The holders 110 include a base section 112 that rests on the top of the tray base. Spaced-apart wall sections 114 extend upwardly from the base section 112 to receive the shanks of the screwdrivers 18 and 20 therebetween. Diagonal webs or ramps 116 extend upwardly along the insides of the wall sections to define a generally V-shaped channel to closely receive the shanks of the screwdrivers.

A connection projection 90 extends downward from the underside of the base section 112 to be snuggly receivable within top socket 40 of a base panel 14. The connection projection 90 can be inserted into a desired top socket 40 so as to position the holders 110 on the tray 10, and thus place the pliers screw drivers at desired locations on the tray 10. Such locations may depend on, for example, the size of the screwdrivers, the size of the tray assembly 10, as well the desired location of the screwdrivers relative to the other tools being held and organized on the tray assembly.

As shown in FIGS. 1, 3, 4A, and 4B, holders 120 are shown as holding wrenches 22, 24, and 26 on tray 10. The holders 120 include a base section 122 that rests on the top of the tray base. Spaced apart wall sections 124 extend upwardly from the base section 122 to receive the wrenches 22, 24, and 26 therebetween. Diagonal or sloped webs or ramps 126 extend upwardly along the insides of the wall sections 124 to define a generally Vee shaped channel to closely receive the shanks or handles of the wrenches 22, 24, and 26.

A connection projection 90 extends downward from the underside of the base section 122 to be snuggly receivable within top socket 40 of a base panel 14. The connection projection 90 can be inserted into a desired top socket 40 so as to position the holders 120 on the tray 10, and thus place the wrenches 22, 24, and 26 at desired locations on the tray 10. Such locations may depend on, for example, the size of the wrenches, the size of the tray assembly 10, as well the desired locations of the wrenches relative to the other tools being held and organized on the tray assembly 10.

As shown in FIGS. 1, 3, 4A, and 4B, holders 130 are shown as holding sockets 28, 30, and 32 on tray 10. The holders 130 include a base section 132 that rests on the top of the tray base. The base section is size and shaped to receive (engage into) the head of the socket, which typically has a through hole that is square in cross section to receive the tang or drive gear projecting from the head of a rachet wrench. The tang or drive gear may be of different sizes, for example, ¼ inch, ⅜ inch, or ½ inch across.

The holders 130 may include a shaft 134 that projects upwardly from the base section to serve as a lead in for the sockets, Also base section 132 may be formed with a connection projection 90 that extends downward from the underside of the base section 132 to be snuggly receivable within top socket 40 of a base panel 14. The connection projection 90 can be inserted into a desired top socket 40 so as to position the holders 130 on the tray 10, and thus place the sockets 28, 30, and 32 at desired locations on the tray 10. Such locations may depend on, for example, the sizes and numbers of sockets, the size of the tray assembly 10, as well the desired location of the sockets relative to the other tools being held and organized on the tray assembly.

While illustrative embodiments have been illustrated and described, it will be appreciated that various changes can be made therein without departing from the spirit and scope of the invention. For example, connection projections, such as a connection projection similar to 56, can be constructed with tongues located at the sides of the body portion, rather than at the bottom of the body portion.

Also, rather than using tongues similar to tongues 68 to lock the connection projection into engagement with an adjacent base panel, the connection projection can be constructed with teeth 9 (for example of a saw tooth shape) disposed along the bottom and/or sides of the body portion 66 to engage corresponding teeth located within the side sockets of the base panel body portion.

As another example, a dove tail or other type of projection can extend outwardly of and along the length of a side of base panel body portion 50 for sliding engagement into a socket extending into and along the side edge of an adjacent body portion 50 so that the corresponding base side edges are in face-to face-relationship to each other. Top sockets, similar to top sockets 40, can be provided for receiving the connection projection portions of tool holders. Handles can be constructed with projections or sockets for engaging the base panels at the end of the tray base.

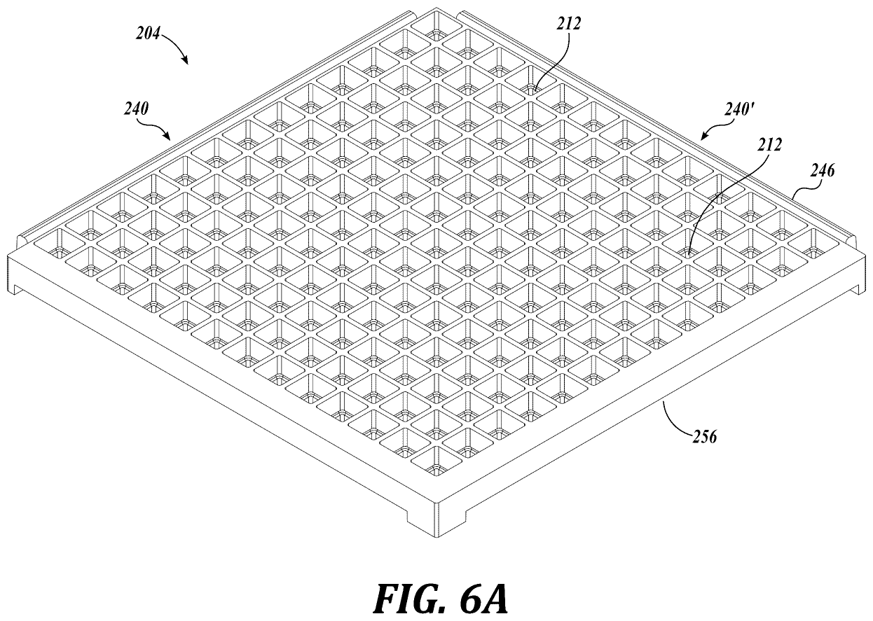

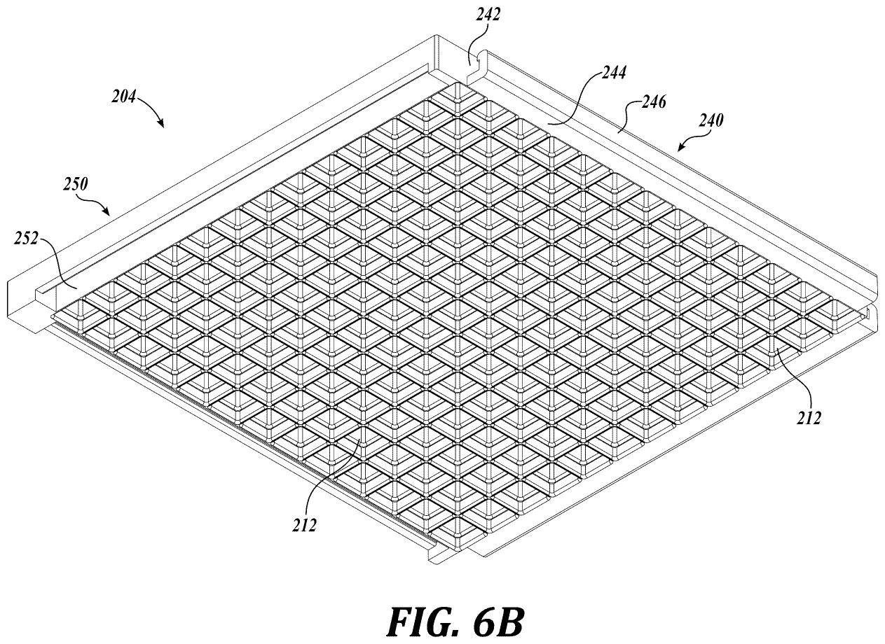

FIGS. 6A-11 disclose another embodiment of the present disclosure, wherein a tray assembly 200 includes in basic form a tray base 202 composed of individual base panels or simply panels 204 that “snap fit” or otherwise locked together to form the base 202 with sufficient strength and durability to hold and support a number of tools, including mechanics tools, in an organized matter. Such mechanics tools can include, for example, pliers, screwdrivers, wrenches, and sockets. Each of these tools can be held in place on the tray base 202 by tool holders secured to the tray base as discussed more fully below.

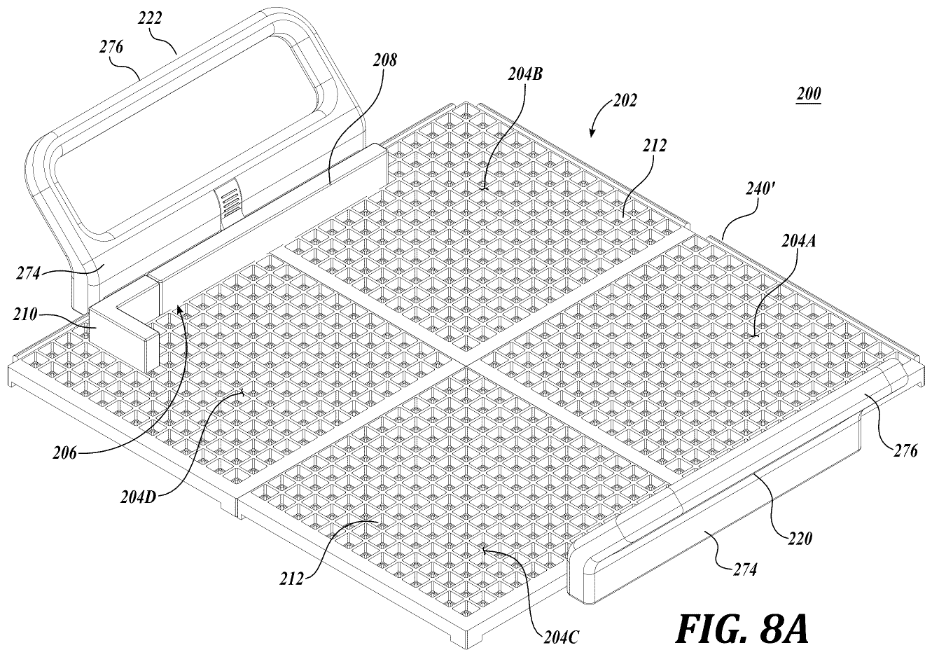

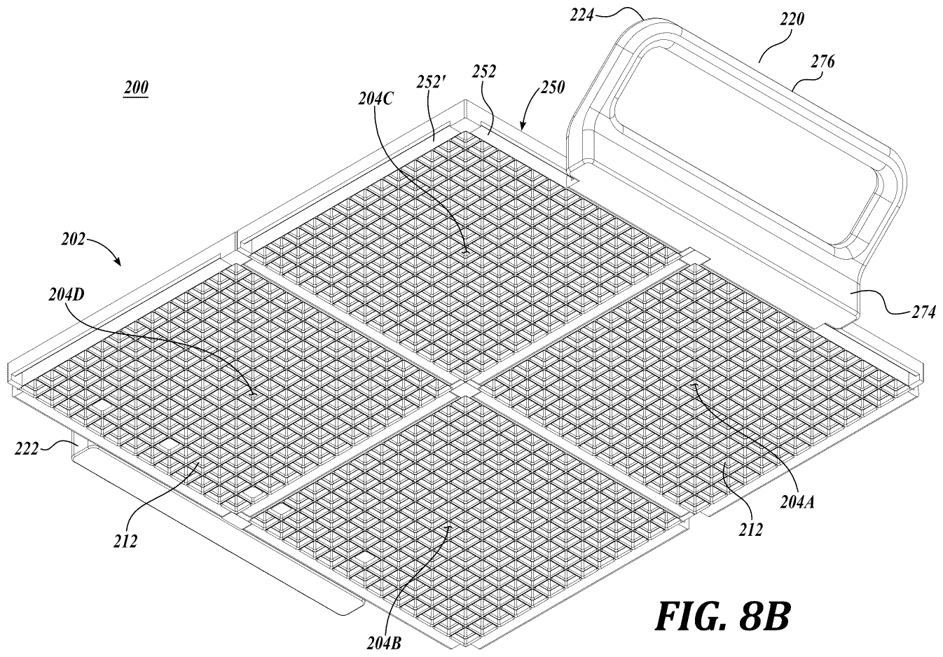

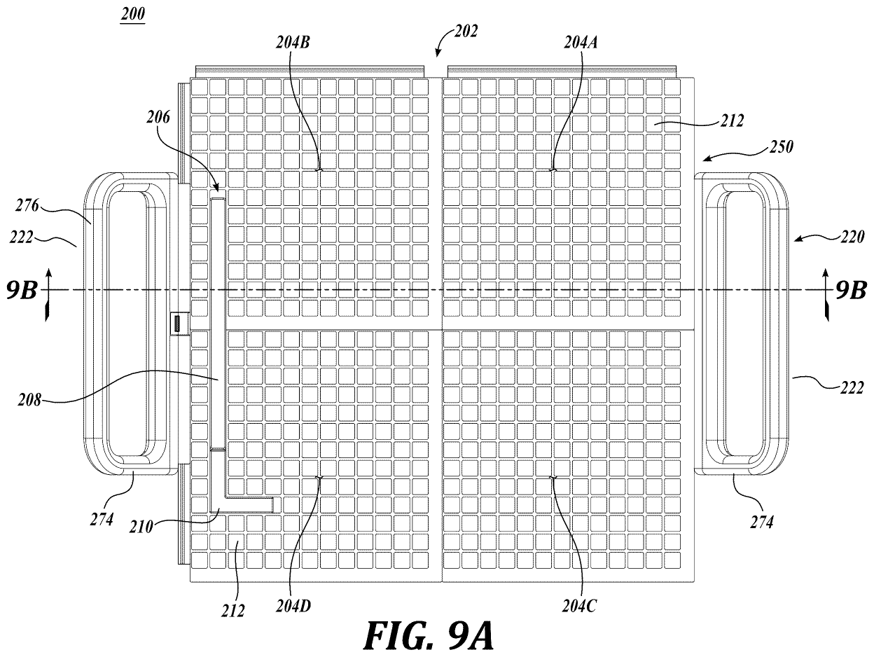

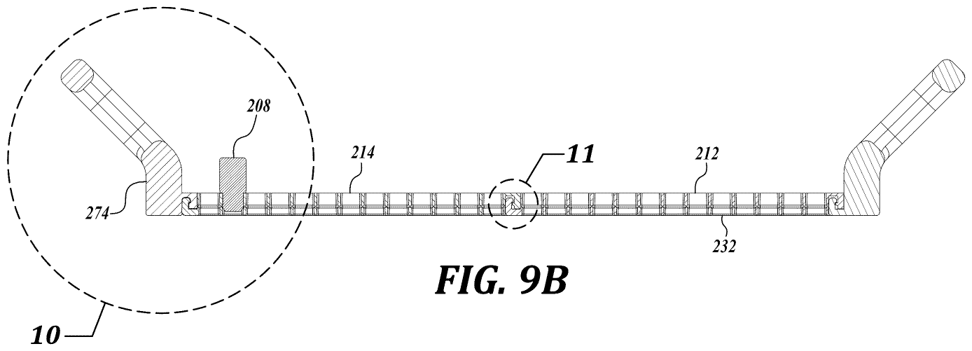

A wall can extend around the perimeter of the tray base 202. A portion 206 of such a wall is shown in FIGS. 8A, 9A, and 9B. The perimeter wall can be composed of longitudinal sections 208 and corner sections 210 that snuggly engage downwardly into openings or cavities or sockets 212 extending downward from the top surface 214 of each panel 204. The perimeter wall helps to retain smaller items as well as nuts, bolts, and other hardware or fasteners on the tray assembly 200. In this regard, divider walls can also be used to form walled sections on the base 202 for holding desired items.

Handles 220 and 222 can be provided so that the tray assembly 200 can be conveniently carried about. The handles 220 and 222 also “snap fit” or otherwise lock with the sides of one or more panels 204 as discussed below.

Although the foregoing briefly describes the basic construction of the tray assembly 200, it is to be understood that the tray assembly 200 need not include all of the above described elements. Rather, the tray assembly 200 is defined by the claims of the present application. Further, it is to be understood that the configuration and construction of the panels 204 constitutes a separate aspect of the present disclosure.

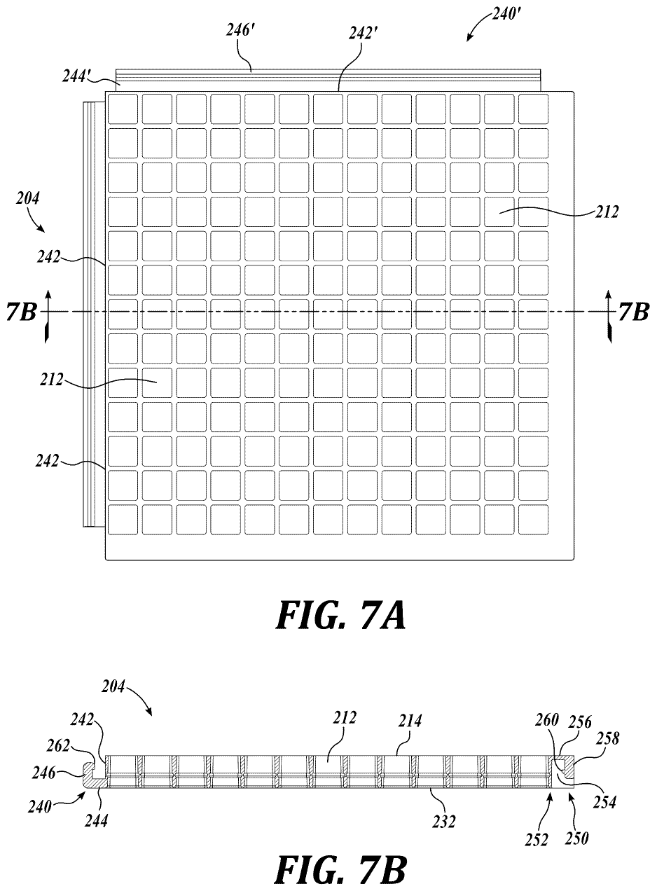

Discussing the construction of the tray assembly 200, in greater detail, as noted above, the tray base 202 of the tray assembly 200 is constructed from individual panels 204, see, for example, FIGS. 6A, 6B, 7A, and 7B. The panels 204 are shown as being square in shape. However, the panels can be of other shapes, including of other rectilinear shapes, such as rectangular, cross-shaped, U-shaped, and angle-shaped.

The example of tray panel 204 is shown in FIGS. 6A, 6B, 7A, and 7B as being of a square shape with the top openings or cavities or sockets 212 extending downwardly from the top surface 214 of the panel 204. Although not essential, the sockets 212 extend all the way through the panel 204 so as to be open at the bottom surface 232 of the panel 204. Alternatively, the bottom surface 232 can be closed off.

The sockets 212 are shown as being of a square cross-sectional shape; however, the sockets 212 can be of other shapes, for example, hexagonal or octagonal. Moreover, the sockets 212 are shown as being in a grid pattern occupying substantially the entire area of the panel 204. However, it is to be understood that the sockets can be arranged in other patterns about the area of the panel 204. Nonetheless, the grid pattern of the sockets 212 provide substantial flexibility in positioning walls or tool holders on the tray base 202 at desired locations as discussed below.

The tray panels 204 can be assembled and locked together to form a continuous tray base 202 of a desired shape and size. In this regard, a male connector structure 240 projects from and extends along the bottom 232 of a first side edge 242 of a panel 204.

The male connector structure 240 is illustrated as being in the form of an elongated blade connector having an elongated web portion 244 extending along the length of the adjacent exterior first side or edge 242 of the panel 204. The bottom edge of an elongated blade 246 is attached to the distal edge of the web portion 244 at a location spaced from the first side edge 242 of the panel 204. The lower surface of the web portion 244 is shown as coplanar with the bottom 232 of the panel 204, but that does not need to be the case. The blade 246 extends upwardly from the web portion 244 to form an upper edge. Typically, the upper edge of the blade 246 does not extend upward as high as the first exterior side or edge 242.

A female connector structure 250 is incorporated into a second side or edge 252 of the panel 204. In this regard, as shown in FIG. 7B, the female connector structure 250 defines a downwardly open slot 254 defined by a web section 256 extending along and outwardly from the second side or edge 252 of the panel 204. The web section 256 is shown as coplanar with the top surface 214 of the panel 204 but need not necessarily be the case.

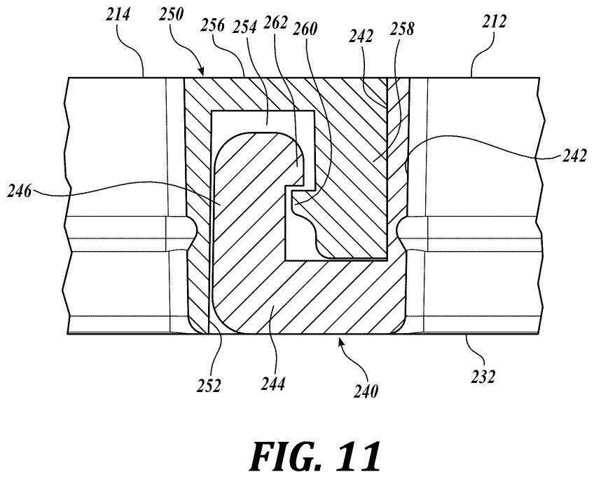

The female connector structure 250 also includes a blade 258 extending downwardly from the web section 256 at a location spaced from the second side or edge 252 to form the downwardly open slot 254. The slot 254 is positioned and sized to closely receive therein the blade 246 of male connector structure 240 of an adjacent panel 204. See, for example, FIGS. 9B and 11.

It will be understood that when engaged within slot 254, the male connector 240 does not extend all the way to the end of the first side edge 242. In this regard, see FIGS. 6A, 6B, and 7A.

A male connector structure 240′ projects from and extends along the bottom 232 of a third side edge 242′ of a panel 204. The male connector structure 240′ is illustrated as being in the same form as male connector structure 240. In this regard, the male connector structure 240′ includes an elongated blade connector having an elongated web portion 244′ extending along the length of the adjacent exterior third side or edge 242′ of the panel 204. The bottom edge of an elongated blade 246′ is attached to the distal edge of the web portion 244′ at a location spaced from the third side edge 242′ of the panel 204. The lower surface of the web portion 244′ is shown as coplanar with the bottom 232 of the panel 204, but that does not need to be the case. The blade 246′ extends upwardly from the web portion 244′, but typically not as high as the third exterior side or edge 242.

A second female connector structure 250,′ which is of the same construction as the first female connector structure 250, is incorporated into a fourth side or edge 252′ of the panel 204. In this regard, the second female connector structure 250′ defines a downwardly open slot 254′ defined by a web section 256′ extending along and outwardly from the fourth side or edge 252′ of the panel 204. The web section 256′ is shown as coplanar with the top surface 214 of the panel 104 but need not necessarily be the case.

The female connector structure 250′ also includes a blade 258′ extending downwardly from the web section 256′ at a location spaced from the fourth side or edge 252 to form the downwardly open slot 254′. The slot is positioned and sized to closely receive therein a blade 246 or 246′ of male connector structure 240 or 240′ of an adjacent panel 204.

By the foregoing construction, the panels 204 can be conveniently assembled together. As one example, FIGS. 8A, 8B, and 9A illustrate a tray assembly 200 of four panels assembled together. However, it is to be understood the tray assemble can be of other configurations.

In FIGS. 8A, 8B, and 9A, merely to facilitate the explanation of one manner in which the tray 200 may be assembled, the four panels 204 are labeled as 204A, 204B, 204C, and 204D. The first panel 204A may conveniently assembled with an adjacent second panel 204B by aligning a side edge 242 of the first panel 204A against the adjacent side edge 252 of the second panel 204B. Then, the blade 246 of the first panel 204A is slid upwardly behind the blade 258 of the second panel 204B so that the blade 246 is held captive within the slot 254 formed between the blade 258 and the second wall 353 of the second panel 204B.

As shown in FIG. 11, when the first panel 204A may be assembled with the second panel 204B, the upper edge of blade 246 of the male connector 240 of the first panel 204A fits against the web 256 of the female connector 250 of the second panel 204B. Likewise, the lower edge of blade 258 of the female connector 250 of the second panel 204B fits against the web 244 of the male connector 240 of the first panel 204A.

Likewise, a third panel 204C may be conveniently assembled with a lateral side edge of the first panel 204A. If the lateral side edge of the first panel 204A is in the form of a female connector 250 as shown in FIGS. 8A, 8B and 9A, then the side edge of the third panel 204C being presented to the lateral side edge of the first panel 240A will be the form of a male connector 240. The third panel 204C is interconnected to the lateral side edge of the first panel 204A in the same manner as discussed above regarding the first panel 204A and the second panel 204B.

A fourth panel 204D can be assembled with both the second 204B and third 204C panels in a similar manner. The fourth panel 204D is aligned with the third panel 204C so that it presents a side edge (female 250) that is complementary with the adjacent side edge (male 240) of the third panel 204C. As such the side edge (male 240_) of the fourth panel 204D that is presented to the adjacent side edge (female 250) of the second panel 204B will automatically be complementary to the adjacent side edge of the second panel 204B. This is a result of each panel 204 being constructed so that the male connectors 240 extend along two adjacent side edges of the panel 204 and the female connectors extend along the opposite two side edges of the panel 204..

A locking system may be provided to lock the panels 204 in engagement with each other. Referring to FIG. 11, first ridge or lip 260 extends along the top of blade 246 to overlie web portion 244 of the male connector 240. A corresponding second ridge or lip 262 extends along the bottom of the blade 258 of the female connector 250 to underlie the web section 256. When the male and female connectors 240 and 250 of adjacent side edges 242 and 250 of the panels 204 are slidably engaged with each other, the blades 246 and 258 flex outwardly from the adjacent side edges 242 and 252 of the panels 204 to allow the lip 260 of the male connector 240 to slide over the lip 262 of the female connector and then securely lock against each other as shown in FIG. 11. In this regard, the blade 246 is tightly engaged within slot 254. As a result, the panels 204 are prevented from vertical movement relative to each other.

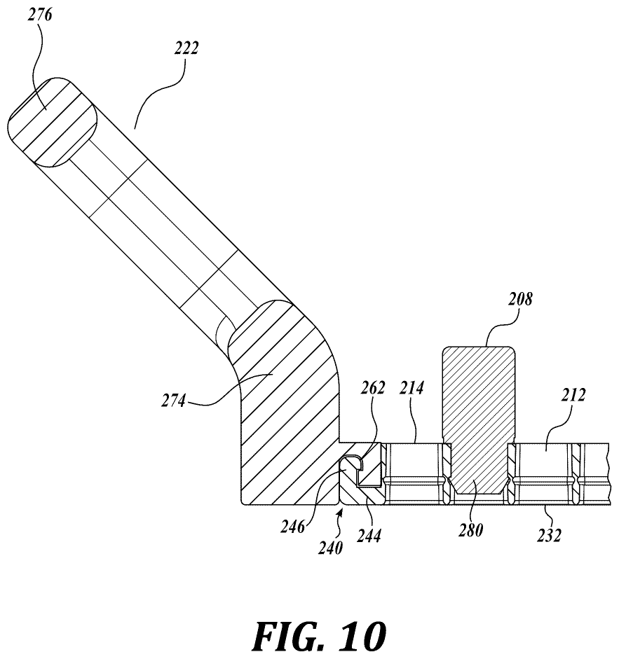

Referring to FIGS. 9A, 9B, and 10, the tray assembly 200 also includes handles 220 and 222 to conveniently and securely manually hold the tray 200 when, for example, carrying the tray from place to place. The handles 220 and 222 include a manually graspable frame 274 that extends upwardly and outwardly from each end of the tray base 202. Although not shown, finger grooves, such as finger grooves 94 shown in FIG. 1, can be provided under the top section 276 of the frame to assist in securely holding the tray handle.

As shown in FIG. 9B, the handles 220 and 222 include female and male connectors 280 and 282, respectively, for attaching the handles 220 and 222 to the panels 204. The handle female connector 280 corresponds to panel female connector 250 so that the handle 220 can be attached the male connector(s) of adjacent panels 204. Likewise, the male handle connector 282 corresponds to the male connector 240 so that the handle 222 can be attached to the female connector(s) 250 of adjacent panels 204. In this manner, the handles 220 and 222 can be attached to the panel(s) 204 in the same manner that panels 204 are attached together as discussed above, thereby providing s secure interconnection with adjacent panel(s) 204.

It is to be understood that the handles 220 and 222 can be of a desired length along the end of the tray assembly 200. The handles 220 and 222 are shown as connecting to two adjacent side-by-side base panels 204. However, the handles 220 and 222 can be of other lengths, and can be configured to connect to the base panel(s) 204 located along the lengths of the handles.

As with the tray assembly 100 discussed above, various configurations of tool holders can be used with the tray assembly 200 to hold different mechanics tools, for example, pliers, screw drives, wrenches, socket wrenches, sockets for socket wrenches, hammers, etc.

Also, holders that correspond with holders 100, 110, 120, and 130 can also be used in conjunction with the tray assembly 200. As such, the descriptions of holders 100, 110, 120, and 130 will not be repeated here, rather reference is made to the descriptions of these types of holders above.

It is noted that at least one connection projection 90 extends downward from the underside of the base sections of the holders 100, 110, 120, 130 to be snuggly receivable within sockets 212 formed in the panels 204. The connection projection can be inserted into a desired socket(s) 212 so as to position the various tools at desired locations on the tray 200. Such locations may depend on, for example, the size of the tool, the size of the tray assembly 200, as well the desired location relative to the other tools being held and organized on the tray assembly.

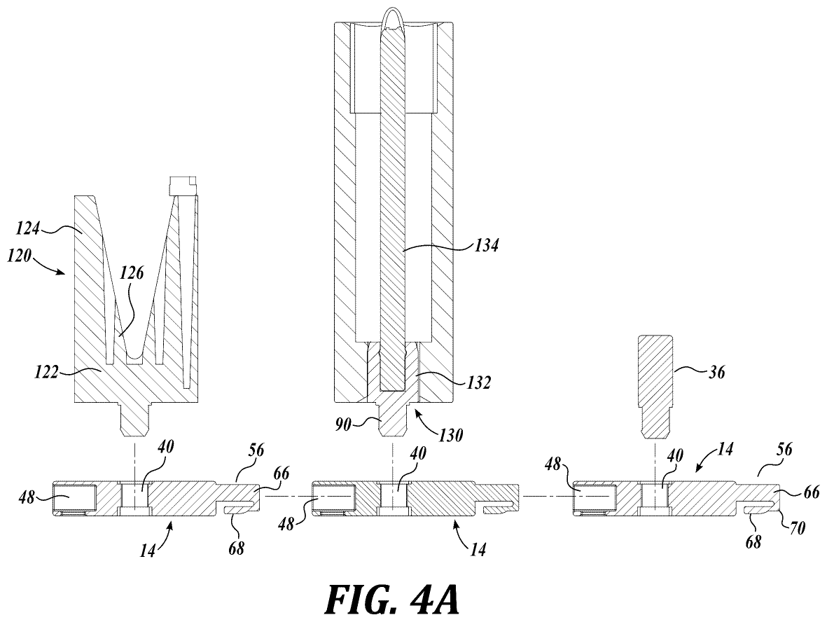

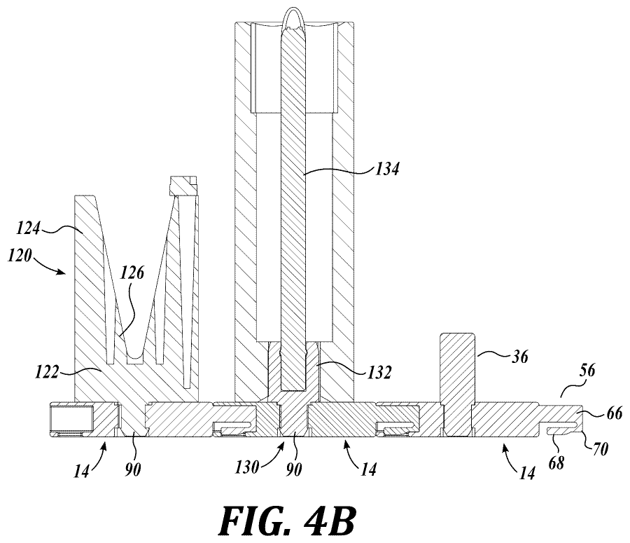

As noted above, a perimeter wall 206 can extend along the perimeter of the tray base 202. A portion of the perimeter wall 206 is shown in FIG. 8A. The perimeter wall 206 may be constructed from longitudinal sections 208 and corner sections 210. The longitudinal sections 208 may be constructed from elongate wall portions resting on the top surface 214 of base panels 204 and downward extending plugs 280 that are sized and shaped to be closely and snuggly inserted into the sockets 212. The intersection of the plugs 280 and the top surface 214 of the panel 204 can be radiused or chamfered to guide the plugs down into the sockets 212 in a manner similar to that shown in FIG. 4A. The plugs 280 are formed in a cross-sectional shape matching that of the sockets so that the longitudinal sections 208 maintain a fixed orientation relative to the panel 204 on which the perimeter wall is located.

The corner sections 210 are constructed similarly to the longitudinal sections 208, but with the exception that the corner sections have two sections at right angles to each other to form a corner. As with the longitudinal sections 208, the corner sections 210 also include a downwardly extending plug 280 to be snugly receivable within a socket 212.

It will be appreciated that the longitudinal sections 208 and corner sections 210 may form a continuous wall or edge on the tray base 202. Although the wall sections 208 are shown as sized to match the base panel 204 on which they are mounted, the wall sections can be longer than a base panel. In this regard, the wall sections can be configured to be engageable with two of even a larger number of separate base panels 204.

Although the wall section 208 and corner sections 210 are shown to form a portion of a perimeter wall 206, such sections can also be used to form one or more dividing walls extending across or along the tray base. In this manner, the tray base can be divided into sections or areas in which particular items may be stored, such as, for example, hardware of a certain size and/or type or fasteners of a certain size and/or type.

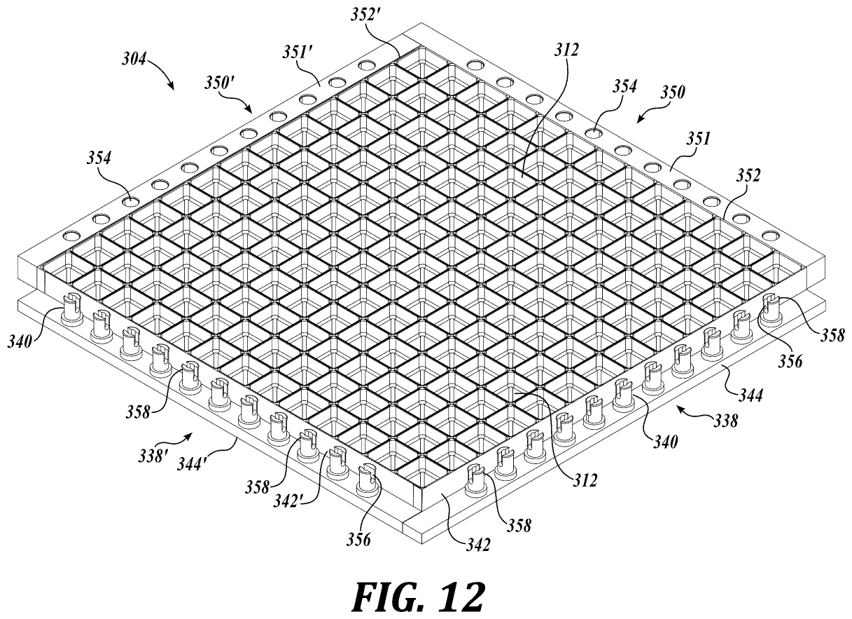

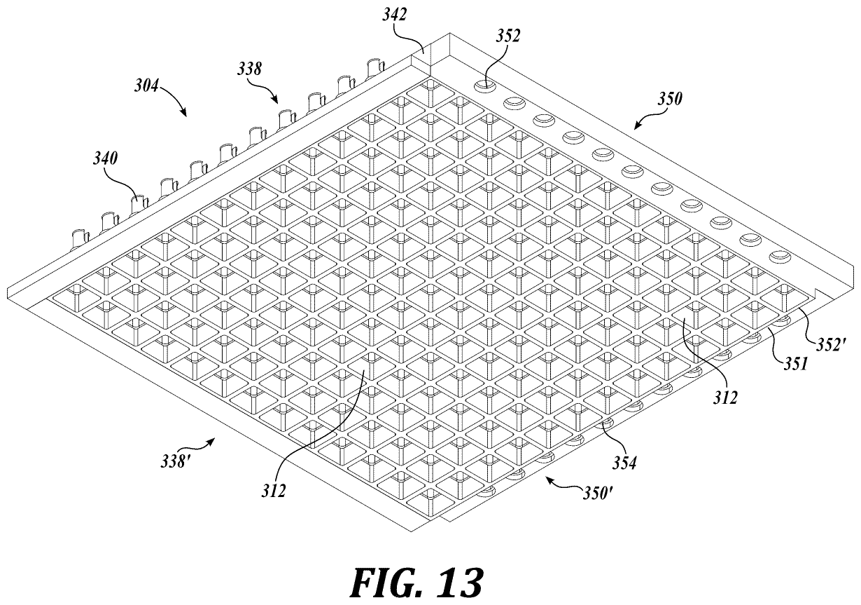

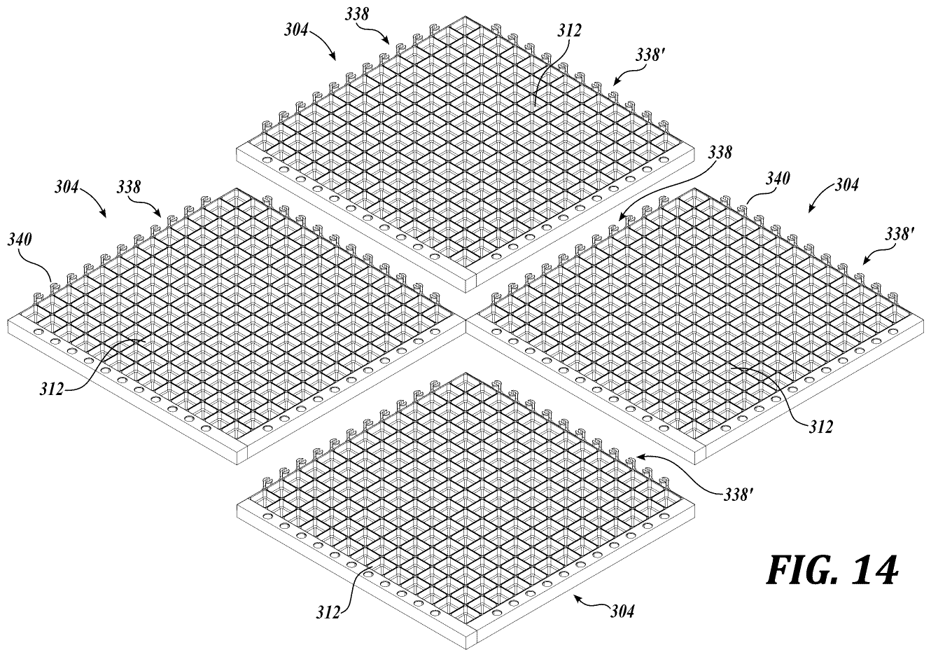

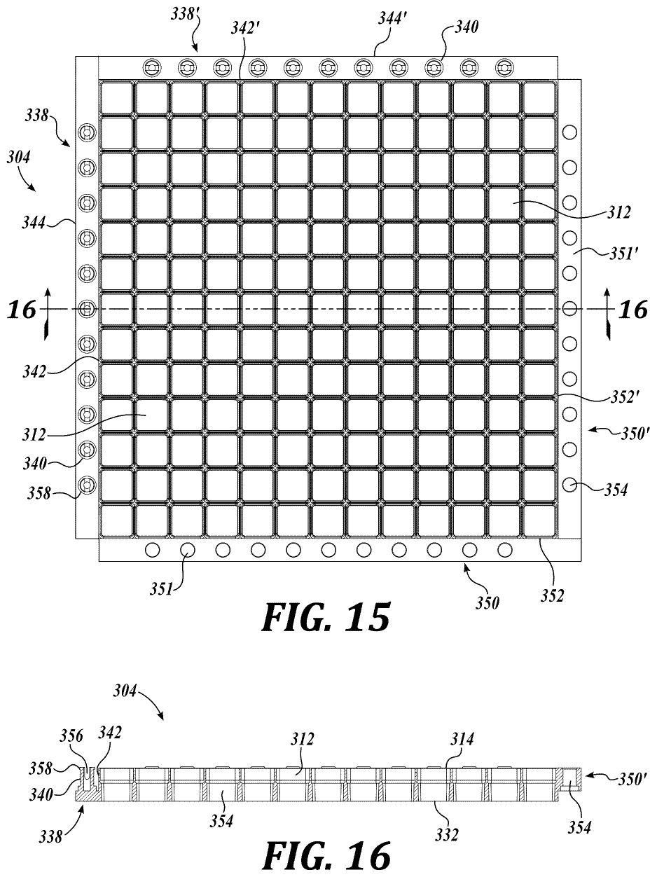

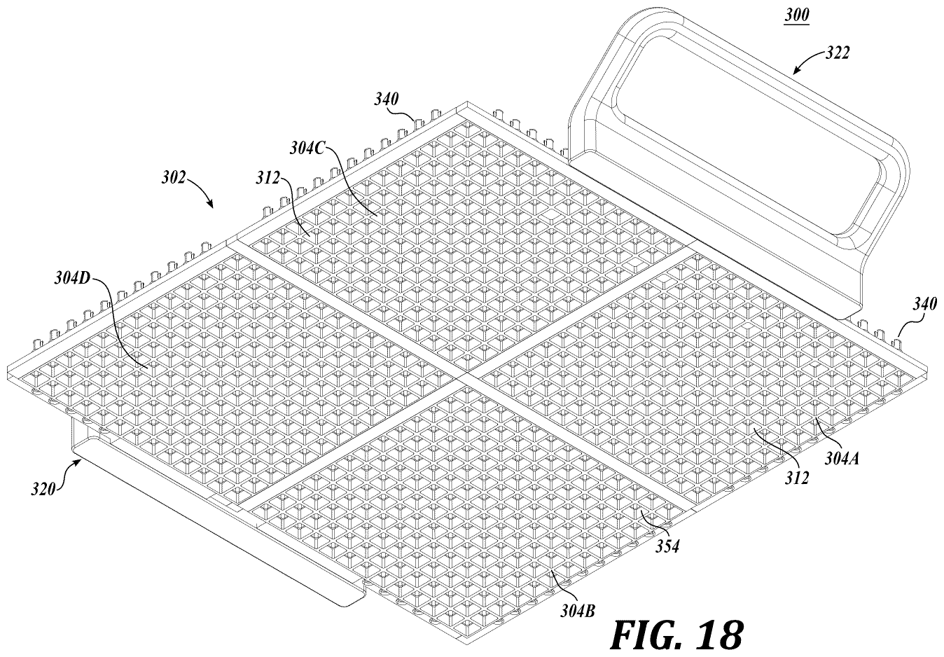

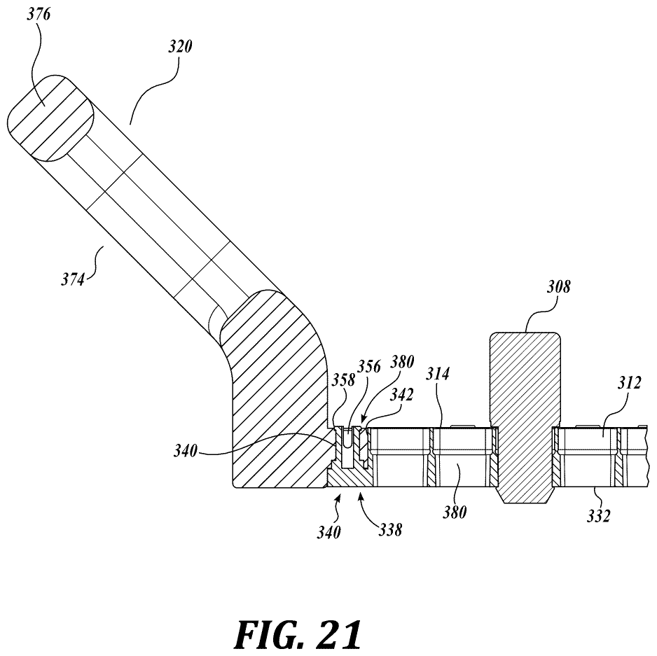

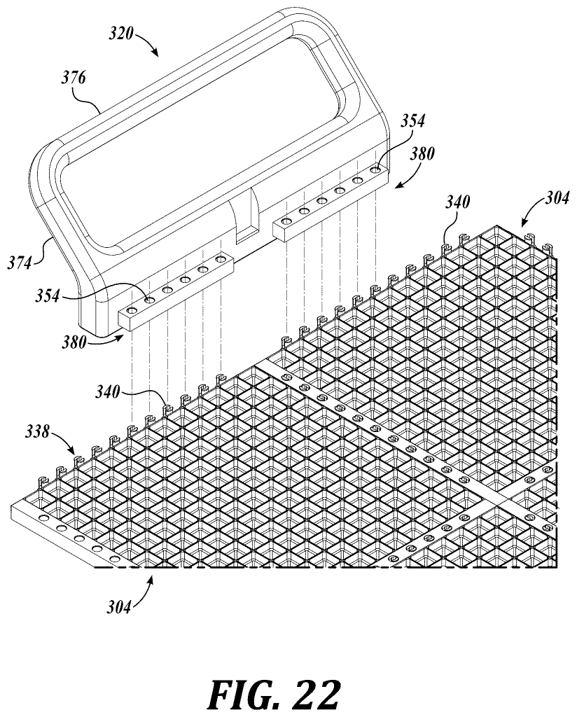

FIGS. 12-22 disclose another embodiment of the present disclosure, wherein a tray assembly 300 includes in basic form a tray base 302 composed of individual base panels or simply panels 304 that “snap fit” or otherwise locked together to form the base 302 with sufficient strength and durability to hold and support a number of tools, including mechanics tools, in an organized matter. Such mechanics tools can include, for example, pliers, screwdrivers, open end or box wrenches, sockets, socket wrenches or rachet wrenches, hammers, chisels. Each of these tools can be held in place on the tray base 302 by tool holders secured to the tray base as discussed more fully below.

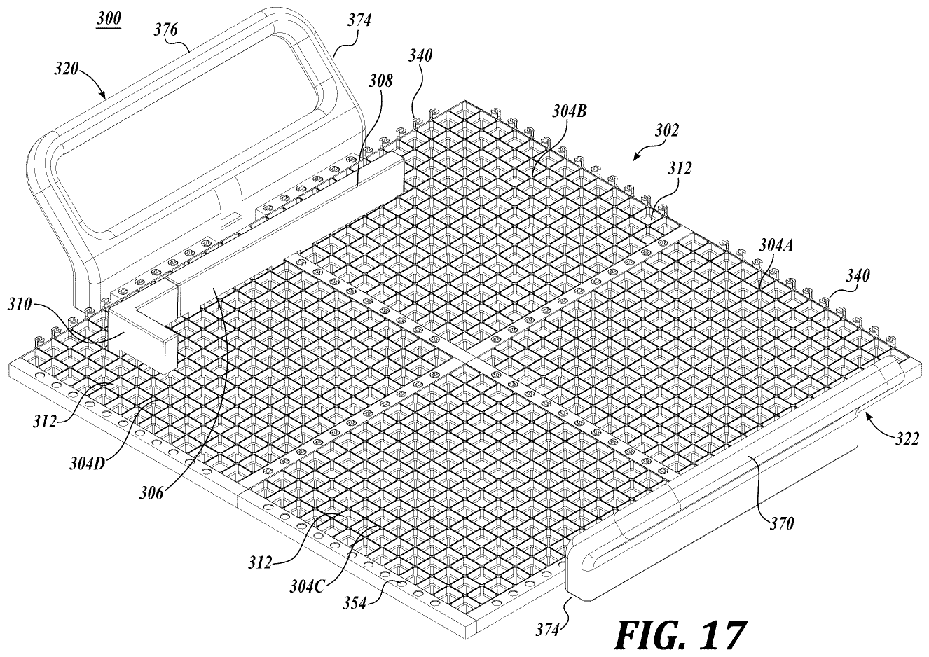

A wall can extend around the perimeter of the tray base 302. A portion 306 of such a wall is shown in FIGS. 17, 19, and 20. The perimeter wall can be composed of longitudinal sections 308 and corner sections 310 that snuggly engage downwardly into apertures, openings, or cavities 312 extending downward from the top surface 314 of each panel 304. The perimeter wall helps to retain smaller items as well as nuts, bolts, and other hardware or fasteners on the tray assembly 300. In this regard, divider walls can also be used to form walled sections on the interior of the base 302 for holding desired items.

Handles 320 and 322 can be provided so that the tray assembly 300 can be conveniently carried about. The handles 320 and 322 also “snap fit” or otherwise lock with the sides of one or more panels 304 as discussed below.

Although the foregoing briefly describes the basic construction of the tray assembly 300, it is to be understood that the tray assembly 300 need not include all of the above described elements. Rather, the tray assembly 300 is defined by the claims of the present application. Further, it is to be understood that the configuration and construction of the panels 304 constitutes a separate aspect of the present disclosure.

Discussing the construction of the tray assembly 300, in greater detail, as noted above, the tray base 302 of the tray assembly 300 is constructed from individual panels 304, see, for example, FIGS. 12, 13, 15, and 16. The panels 304 are shown as being square in shape. However, the panels 304 can be of other shapes, including of other rectilinear shapes, such as rectangular, cross-shaped, U-shaped, L-shaped and angle-shaped.

The example of tray panel 304 is shown in FIGS. 12, 13, 15, and 16 as being of a square shape with the top apertures, openings, or cavities 312 extending downwardly from the top surface 314 of the panel 304. Although not essential, the apertures 312 may extend all the way through the panel 304 so as to be open at the bottom surface 332 of the panel 304. Alternatively, the bottom surface 332 can be closed off.

The apertures 312 are shown as being of a square cross-sectional shape; however, the apertures 312 can be of other shapes, for example, hexagonal or octagonal. Moreover, the apertures 312 are shown as being in a grid pattern occupying substantially the entire area of the panel 304. However, it is to be understood that the apertures can be arranged in other patterns about the area of the panel 304. Nonetheless, the grid pattern of the apertures 312 provide substantial flexibility in positioning walls or tool holders on the tray base 302 at desired locations, as discussed below.

The tray panels 304 can be assembled and locked together to form a continuous tray base 302 of a desired shape and size. In this regard, a male connector structure 338 projects from first side edge 342 of a panel 304.

The male connector structure 338 is illustrated as being in the form of a series of spaced apart tubes or tubular members 340 extending along and spaced outwardly from the first side edge 342 of the panel 304. The tubes or tubular members 340 extend upwardly from a first ledge 344 extending along the length of the adjacent exterior of the first side or edge 342 of the panel 304. The bottom or base of each tubular member 340 is attached to the top surface of the first ledge 344 at locations spaced from the first side edge 342 of the panel 304.

The lower surface of the first ledge 344 is shown as coplanar with the bottom 332 of the panel 304, but that does not need to be the case.

A female connector structure 350 in the form of a second ledge 351 is incorporated into a second side or edge 352 of the panel 304. In this regard, as shown in FIGS. 12, 13, 15, and 16, the female connector structure 350 defines a series of spaced sockets or through holes 354 formed in the second ledge 351 and extending along and positioned outwardly from the second side or edge 352 of the panel 304. The second ledge 351 is shown as being coplanar with the top surface 314 of the panel 304, but this need not necessarily be the case.

The sockets or through holes 354 are spaced apart from each other and are sized to closely receive therein the tubular members 340 of the male connector structure 338. In this regard, in one form of the present disclosure, the tubes or tubular members 340 can be generally cylindrical in form with a longitudinal slot 356 formed in at least one wall of the tubular member 340. Alternatively, the slot 356 can extend across the diameter of the tubular member 340, thereby to form aligned slots 356 on diametrically opposite sides of the tubular member.

By the foregoing construction, the diametrically opposite sides of halves of the tubular members 340 can flex towards each other when engaged into a socket 354 and thereby impose a load against the interior of the socket 354 to help lock the tubular member 340 in engagement with the socket.

The tubular members 340 can also be constructed with a flange or rim 358 at their distal (upper) ends to extend outward of the tubular member per se. As can be appreciated, when the tubular members 340 are fully engaged into a socket 354, the flange 358 extends over the upper surface of the second ledge 351 beyond the socket 354, thereby to prevent withdrawal of the tubular member from a corresponding socket 354. In order to remove the tubular member 340 from a socket 354, it would be necessary to squeeze the split ends of the tubular member halves together so that the flange 358 can pass through the socket.

The male members 340 can be constructed in a manner other than described above. For, example the male members can be in the form of a circular post with a slot, similar to slot 356, formed in the post. The width of the slot can be selected so that the remaining spaced apart sections or halves of the slotted post can be flexed towards each other for engagement into a corresponding socket 354.

Further, a flange or rim similar to flange 358 can be formed at the top distal end of the male member to function in the manner of flange 358 described above.

A male connector structure 338′ extends along the bottom of a third side edge 342′ of the panel 304. The male connector structure 338′ may be of the same form as male connector structure 338. In this regard, the male connector structure 338′ is in the form of a series of spaced apart tubes or tubular members 340′ extending upwardly from a third ledge 344′ that extends along the length of the adjacent exterior of the third side or edge 342′ of the panel 304. The bottom of each tubular member 340′ is attached to the top surface of the third ledge 344′ at locations spaced from the third side edge 342′ of the panel 304. The lower surface of the third ledge 344′ is shown as coplanar with the bottom 332 of the panel 304, but that does not need to be the case.

A second female connector structure 350,′ which may be of the same construction as the first female connector structure 350, is incorporated into a fourth side or edge 352′ of the panel 304. In this regard, the second female connector structure 350′ defines a series of spaced apart sockets or through holes 354′ formed in the fourth ledge 351.′ The sockets 354′ extend along the fourth ledge 351′ at locations outwardly from the fourth side or edge 352′ of the panel 304. The fourth ledge 351′ is shown as coplanar with the top surface 314 of the panel 304 but need not necessarily be the case.

The sockets 354′ are spaced apart from each other and are sized to closely receive therein the tubular members 340 or 340′ of male connector structure 338 or 338′. Further the male connector structure 338,′ including the tubular members 340,′ can be of a construction that is similar or the same as the male connector structure 338 and tubular members 340 described above.

By the foregoing construction, the panels 304 can be conveniently assembled together. As one example, FIGS. 17-19 illustrate a tray assembly 300 of four panels 304 assembled together. However, it is to be understood the tray assembly can be of other configurations.

In FIGS. 17-19, merely to facilitate the explanation of one manner in which the tray 300 may assembled, the four panels 304 are labeled as 304A, 304B, 304C, and 304D. The first panel 304A may be conveniently assembled with an adjacent second panel 304B by aligning a side edge 342 of the first panel 304A against the adjacent side edge 352 of the second panel 304B. Then, the tubes 340 of the first panel 304A are slid upwardly into the sockets 354 of the female connector structure 350 of the second panel 304B so that the tubes 340 are held captive within the sockets 354 of the female connector structure 350 of the second panel 304B.

As shown in FIGS. 17-19, when the first panel 304A is assembled with the second panel 304B, the tubes 340 of the male connector structure 338 of the first panel 204A engages into and through sockets 354 of the female connector structure 350 of the second panel 204B. Further, the flanges 358 of the tubes 340 extend over the upper surface of the ledge 351 of the female connector structure 350 thereby to prevent withdrawal of the tubular member 340 from a corresponding socket 354.

Likewise, a third panel 304C may be conveniently assembled with a lateral side edge of the first panel 304A. If the lateral side edge of the first panel 304A is in the form of a female connector structure 350, then the side edge of the third panel 304C being presented to the lateral side edge of the first panel 304A will be the form of a male connector structure 338. The third panel 304C is interconnected to the lateral side edge of the first panel 304A in the same manner as discussed above regarding the first panel 304A and the second panel 304B.

A fourth panel 304D can be assembled with both the second 304B and third 304C panels in a similar manner. The third panel 304C is aligned with the fourth panel 304D so that it presents a side edge (e.g., female connector structure 350) that is complementary with the adjacent side edge (e.g., male connector structure 338) of the third panel 304C. As such the side edge (male connector structure 338) of the fourth panel 304D that is presented to the adjacent side edge of the second panel 304B (female connector structure 350) will automatically be complementary to the adjacent side edge of the second panel 304B. This is a result of each panel 304 being constructed so that the male connector structures 338 extend along two adjacent side edges of the panels 304 and the female connectors structures 350 extend along the opposite two side edges

Referring to FIGS. 17-22, the tray assembly 300 also may include handles 320 and 322 to conveniently and securely hold the tray 300 when, for example, carrying the tray form place to place. The handles 320 and 322 include a manually graspable frame 374 that extends upwardly and outwardly from each end of the tray base 302. Although not shown, finger grooves, such as finger grooves 94 shown in FIG. 1, can be provided under the top section 376 of the frame 374 to assist in securely holding the tray handles 320 and 322.

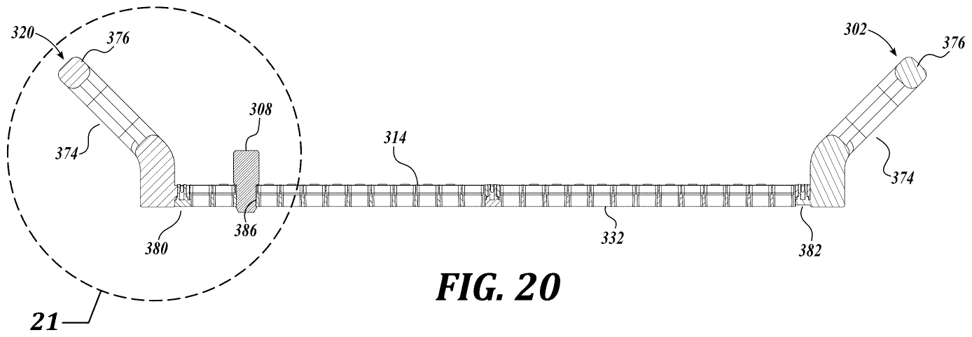

As shown in FIGS. 20-22, the handles 320 and 322 include female and male connector structures 380 and 382, respectively, for attaching the handles 320 and 322 to the panels 304. The handle female connector structure 380 corresponds to panel female connector structure 350 so that the handle 320 can be attached to the male connector structure 338 of adjacent panels 304. Likewise, the male handle connector structure 382 corresponds to the male connector 338 so that the handle 382 can be attached to the female connector structure 350 of adjacent panels 304. In this manner, the handles 320 and 322 can be attached to the panel(s) 304 in the same manner that panels 304 are attached together as discussed above, thereby providing s secure interconnection with adjacent panel(s) 304.

It is to be understood that the handles 320 and 322 can be of a desired length along the ends of the tray assembly 300. The handles 320 and 322 are shown as connecting to two adjacent side-by-side base panels 304. However, the handles 320 and 322 can be of other lengths, and can be configured to connect to the base panel(s) 204 located along the lengths of the handles.

As with the tray assemblies 100 and 200 discussed above, various configurations of tool holders can be used with the tray assembly 300 to hold different mechanics tools, for example, pliers, screw drives, wrenches, socket wrenches, sockets for socket wrenches, hammers, etc.

Also, holders that correspond with holders 100, 110, 120, and 130 can also be used in conjunction with the tray assembly 300. As such, the descriptions of holders 100, 110, 120, and 130 will not be repeated here, rather reference is made to the descriptions of these types of holders above.

It is noted that at least one connection projection 90 extends downward from the underside of the base sections of the holders 100, 110, 120, 130 to be snuggly receivable within apertures 312 formed in the panels 304. The connection projection 90 can be inserted into a desired aperture(s) 312 so as to position the various tools at desired locations on the tray 300. Such locations may depend on, for example, the size of the tool, the size of the tray assembly 300, as well the desired location relative to the other tools being held and organized on the tray assembly.

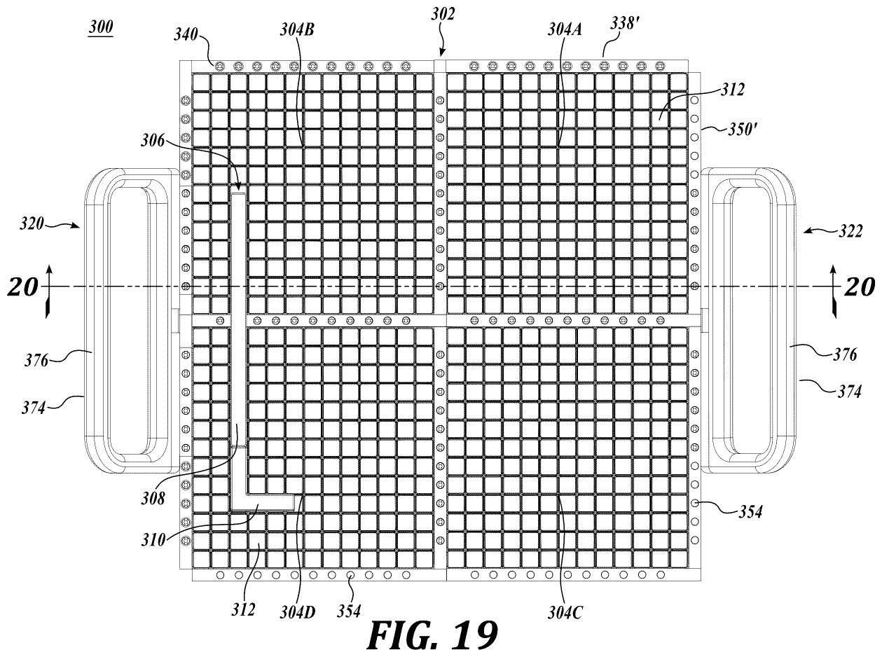

As noted above, a perimeter wall can extend along the perimeter of the tray base 202. A portion 306 of the perimeter wall is shown in FIGS. 17 and 19. The perimeter wall may be constructed from longitudinal sections 308 and corner sections 310. The longitudinal sections 308 may be constructed from elongate wall portions resting on the top surface 314 of base panels 304 and downward extending plugs 386, corresponding to the connection projections 90 noted above, that are sized and shaped to be closely and snuggly inserted into the apertures 312.

The intersection of the plugs 386 and the top surface 314 of the panel 304 can be radiused or chamfered to guide the plugs down into the apertures 312 in a manner similar to that shown in FIG. 4A. The plugs 386 are formed in a cross-sectional shape matching that of the apertures so that the longitudinal wall sections 308 maintain a fixed orientation relative to the panel(s) 304 on which the perimeter wall is located.

The corner sections 310 are constructed similarly to the longitudinal sections 308, but with the exception that the corner sections have two sections at right angles to each other to form a corner. As with the longitudinal sections 308, the corner sections 310 also include a downwardly extending plug 386 to be snugly receivable within an aperture 312.

It will be appreciated that the longitudinal sections 308 and corner sections 310 may form a continuous perimeter wall or edge on the tray base 202. Although the wall sections 308 are shown as sized to match the base panel 304 on which they are mounted, the wall sections can be longer than a base panel. In this regard, the wall sections can be configured to be engageable with two of even a larger number of separate base panels 304.

Although the wall longitudinal sections 308 and corner sections 310 are shown to form a portion of a perimeter wall, such sections can also be used to form one or more dividing walls extending across or along the tray base. In this manner, the tray base can be divided into sections or areas in which particular items may be stored, such as, for example, hardware of a certain size and/or type or fasteners of a certain size and/or type.

The embodiments of the invention in which an exclusive property or privilege is claimed are defined as follows:

1. A modular tool tray organizer, comprising a plurality of rectilinear-shaped panels interlockable together to form in a desired configuration base of the tool tray organizer, the panels comprising:
side edges;
a bottom portion;
a first series of tubes projecting from a first side edge of a panel;
a first series of sockets formed in a second side edge of the panel; and
the panel and a first adjacent panel interconnected by engaging the first series of tubes projecting from the panel into a series of sockets of the first adjacent panel.

2. The modular tool tray organizer of claim 1, wherein the first series of tubes extend along and are spaced from the first side edge of the panel.

3. The modular tool tray organizer of claim 2, wherein the first series of tubes extending upwardly from a first ledge extending along the first side edge of the panel.

4. The modular tool tray organizer of claim 3, wherein the first series of sockets extend along a second ledge extending along the second side edge of the panel.

5. The modular tool tray organizer of claim 1, comprising a second series of tubes projecting from a third side edge of the panel adjacent the first side edge of the panel and a second series of sockets formed in a fourth side edge of the panel adjacent the second side edge of the panel.

6. The modular tool tray organizer of claim 5, wherein the second series of tubes extend along and are spaced from the third side edge of the panel.

7. The modular tool tray organizer of claim 6, wherein the second series of tubes extend upwardly from a third ledge extending along the third side edge of the panel.

8. The modular tool tray organizer of claim 7, wherein the second series of sockets extend along a fourth ledge extending along a fourth side edge of the panel.

9. The modular tray organizer of claim 1, wherein the tubes have at least one slot formed in the tube and extending along the length of the tube.

10. The modular tray organizer of claim 9, wherein the tubes have a distal end and the slot extends to the distal end of the tube.

11. The modular tray organizer of claim 10, wherein the tubes define a rim portion extending outwardly from the distal ends of the tubes.

12. The modular tray organizer of claim 1, wherein the tubes have at least two slots formed in the tube and extending along the length of the tube.

13. The modular tray organizer of claim 12, wherein the tubes have a distal end and the at least two slots extend to the distal end of the tubes.

14. The modular tray organizer of claim 13, wherein the tubes define rim portions extending outwardly from the distal ends of the tubes.

15. The modular tray organizer of claim 1, wherein the panel is configured to define a top portion and a plurality of apertures extending downwardly from the top portion.

16. The modular tray organizer of claim 15, wherein the apertures occupy substantially the entire area of the panel.

17. The modular tool tray organizer according to claim 15, further comprising at least one tool holder configured to receive a mechanics tool, the tool holder comprising a downwardly extending projection receivable into at least one aperture of a panel.

18. The modular tool tray organizer according to claim 15, further comprising a wall structure comprising a plurality of wall sections, at least one downwardly extending projection extending downwardly from the wall sections to be receivable within at least one aperture of a panel, with the wall section extending along the top portion of the panel.

19. The modular tool tray organizer according to claim 15, further comprising a handle engageable with at least one panel, the handle comprising a manually graspable section and a base section, and either a series of tubes projecting from the base section of the handle to be receivable within the series of slots of the panel or a series of slots formed in the base section of the handle to engage with a series of tubes of the panel.

20. A modular tool tray organizer, comprising a plurality of rectilinear-shaped panels interlockable together to form the tool carrying portion of the tool tray organizer of a desire configuration, each of the panels comprising:
four side edges;
a bottom portion;
a first series of tubular connectors extending along and projecting from a first side edge of the panel;
a first series of slots extending along a second side edge of the panel;
a second series of tube connectors extending along and projecting from a third side edge of the panel;
a second series of slots extending along a fourth side edge of the panel;
wherein two panels are interconnected by engaging the first or second series of blade connectors of a first panel into a first or second series of slots of an adjacent second panel.

21. The modular tool tray organizer of claim 20, wherein each of the base panels is configured to define a top portion and a plurality of apertures extending downwardly from the top portion, wherein the apertures are configured to receive a plug extending downwardly from a structure selected from the group consisting of a tool holder configured to receive a mechanics tool and a wall structure section, the wall structure section configurable to form part of a perimeter wall or a dividing wall of the tool tray organizer.

22. A modular tool tray organizer, comprising a plurality of rectilinear-shaped panels interlockable together to form in a desired configuration of the base of the tool tray organizer, the panels comprising:
side edges;
a bottom portion;
a male connector structure projecting from a first side edge of a panel;
a female connector structure formed along a second side edge of the panel; and
the panel and a first adjacent panel interconnected by engaging the male connector structure of the panel with a female connector structure of the first adjacent panel.

23. The modular tray organizer of claim 22, wherein the male connector structure comprising at least one male projection member projecting from the first side edge of the panel, and the female connector structure is configured to receive the at least one male projection member.

24. The modular tray organizer of claim 23, wherein the at least one male projection member is selected from the group including a plug, a detent, a blade, a tube, a post; and wherein the female connector structure is configured to receive the plug, detent, blade, tube, and post, respectively.
